(19) United States
(12) Patent Application Publication
(10) Pub. No.: US 2026/0129662 A1
(43) Pub. Date: May 7, 2026

(54) COMMAND SCHEDULING FOR INTERNET OF THINGS (IoT)

(71) Applicant: InterDigital Patent Holdings, Inc., Wilmington, DE (US)

(72) Inventors: Martino FREDA, Laval (CA); Jongwoo Hong, New York, NY (US); Kevin Wanuga, Souderton, PA (US); Paul Marinier, Brossard (CA); Aata El Hamss, Laval (CA); Erdem Bala, East Meadow, NY (US); Remun Koirala, London (GB)

(73) Assignee: InterDigital Patent Holdings, Inc., Wilmington, DE (US)

(21) Appl. No.: 18/936,692

(22) Filed: Nov. 4, 2024

(51) Int. Cl. H04W 72/51

(52) U.S. Cl. CPC H04W 72/51

(57) ABSTRACT

Methods and apparatuses are described herein for command scheduling in Internet of Things (IoT). A wireless transmit/receive unit (WTRU) may receive, from a base station (BS), resource configuration information that comprises one or more resource groups. Each of the one or more resource groups may comprise one or more resources. The WTRU may receive, from one or more devices, one or more respective device identifications that correspond to the one or more devices. For the one or more resource groups, the WTRU may determine whether one or more commands are pending for the one or more devices. The WTRU may select, based on one or more resources in a resource group, a device identification associated with a pending command from among the one or more device identifications. The WTRU may transmit, based on the selected device identification, the pending command using the one or more resources in the resource group.

### BACKGROUND

Ambient Internet of Things (AIoT) services utilize IoT-enabled devices to monitor and manage environments or assets seamlessly, often in real-time, without requiring direct user intervention. In AIoT services, inventory procedures primarily involve a reader initiating access to multiple IoT-enabled devices. Additionally, the AIoT service supports command-based actions triggered through inventory and command procedures. However, these procedures require additional resources for command transmission by the reader and potential data reception from the IoT-enabled devices. Current approaches to scheduling these resources are often impractical due to the complexity of the reader and/or devices.

### SUMMARY

Methods and apparatuses are described herein for command scheduling in Internet of Things (IoT). For example, a wireless transmit/receive unit (WTRU) may receive, from a base station (BS), resource configuration information that comprises one or more resource groups. Each of the one or more resource groups may comprise one or more resources. The WTRU may receive, from one or more devices, one or more respective device identifications that correspond to the one or more devices. For the one or more resource groups, the WTRU may determine whether one or more commands are pending for the one or more devices. The WTRU may select, based on one or more resources in a resource group, a device identification associated with a pending command from among the one or more device identifications. The WTRU may transmit, based on the selected device identification, the pending command using the one or more resources in the resource group.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example inventory procedure;

FIG. 3 is a diagram illustrating an example random access procedure;

FIG. 4 is a diagram illustrating an example inventory procedures;

FIG. 5 is a diagram illustrating an example topology;

FIG. 6 is a diagram illustrating another example topology;

FIG. 7A is a diagram illustrating another example topology;

FIG. 7B is a diagram illustrating another example topology;

FIG. 8 is a diagram illustrating another example topology;

FIG. 9A is a diagram illustrating an example resource allocation;

FIG. 9B is a diagram illustrating another example resource allocation;

FIG. 9C is a diagram illustrating another example resource allocation;

FIG. 10 is a diagram illustrating an example transmission indicating a command interrupt;

FIG. 11 is a diagram illustrating an example procedure;

FIG. 12 is a diagram illustrating an example resource configuration;

FIG. 13 is a diagram illustrating an example procedure; and

FIG. 14 is a diagram illustrating another example procedure.

### DETAILED DESCRIPTION

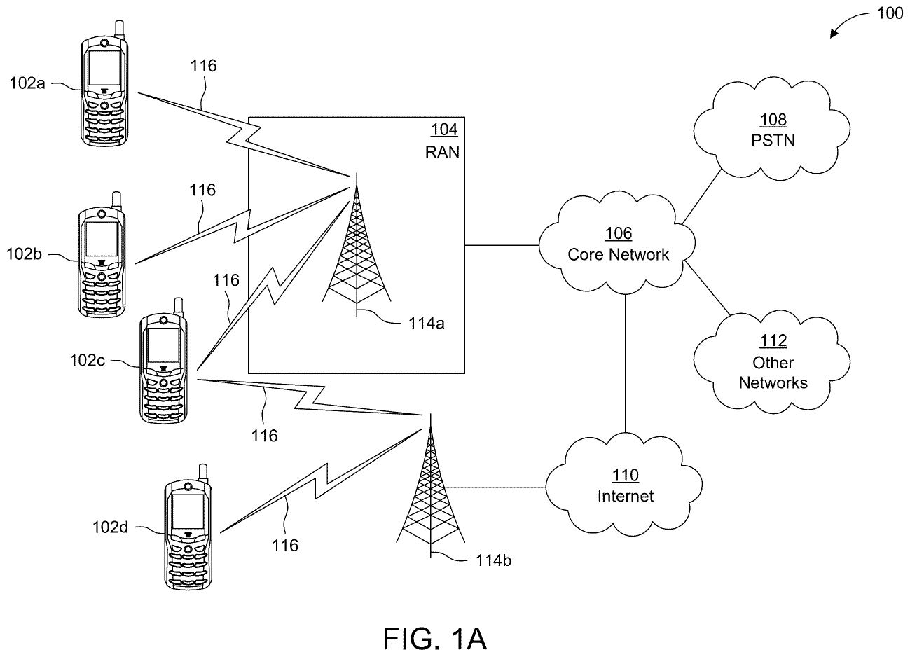

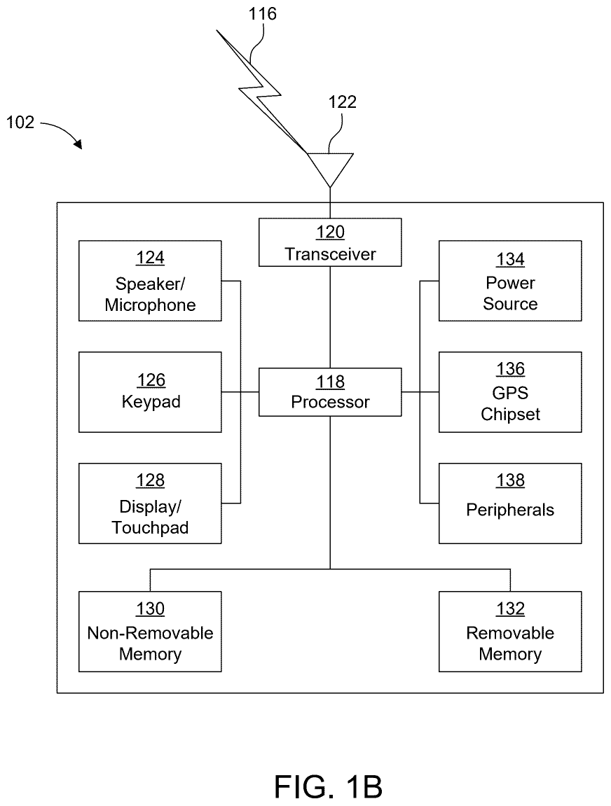

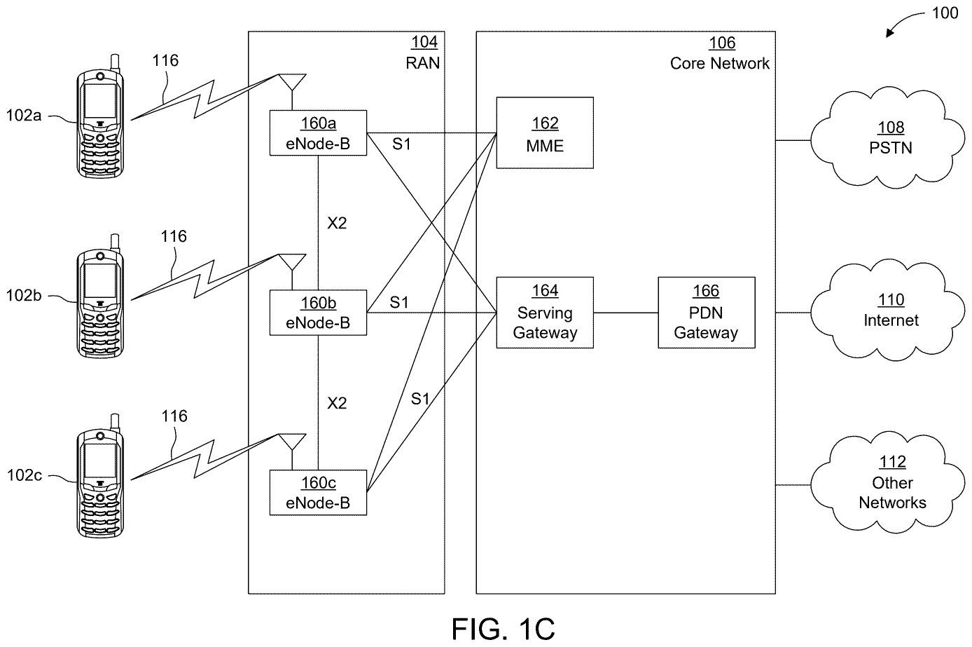

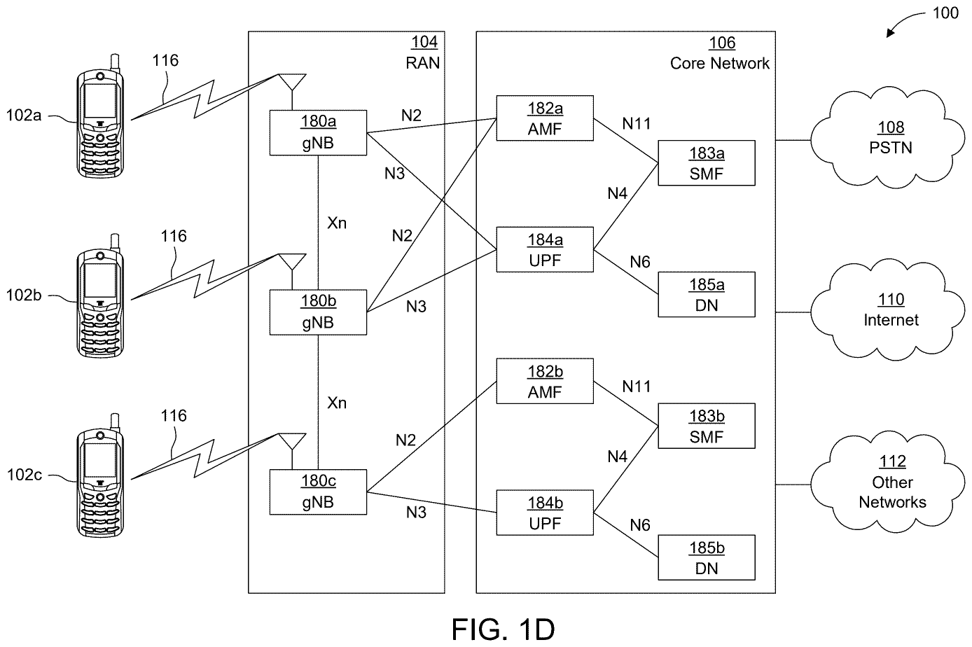

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing devices (e.g., cellular devices) may not work well with energy harvesting due to their peak power consumption of higher than 10 mW.

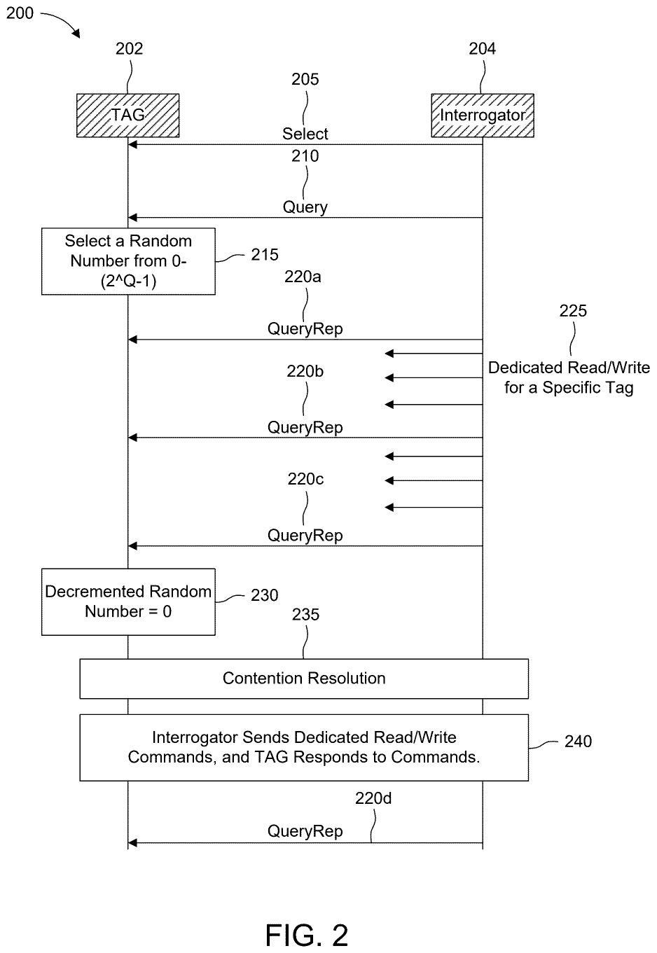

FIG. 2 illustrates an example inventory procedure 200, which may be used in combination with any of other embodiments described herein. The inventory procedure 200 may be used for RFID, which may be used for applications of asset identification. As illustrated in FIG. 2, an interrogator 204 (or a reader) may send a select message at 205 to filter and choose which tags to interact with from a large group of tags. The select message at 205 may set criteria or filters to reduce the number of tags that will respond to the interrogator 204. The interrogator 204 (or a reader) may send a query message at 210 to energize all or a subset of tags. Following the query message at 210, a tag 202 may select a random number from 0-2\hat{ }Q−1 at 215 and load its memory with that number. At each transmission of a QueryRep 220a-c, the tag 202 may decrement its counter until the counter reaches 0. Once the correct tag is selected, the interrogator 204 may issue a dedicated read or dedicated write command at 225 to retrieve or update the data stored on the tag. When the counter reaches 0 at 230, the tag 202 may initiate a contention resolution procedure at 235 which comprises transmitting its device ID in the uplink and waiting for confirmation of the device ID in the downlink (e.g., to address possible collision between multiple devices selecting the same random number). For a device that has passed contention resolution, the interrogator 204 may send multiple read/write commands at 240, to which the tag 202 may respond.

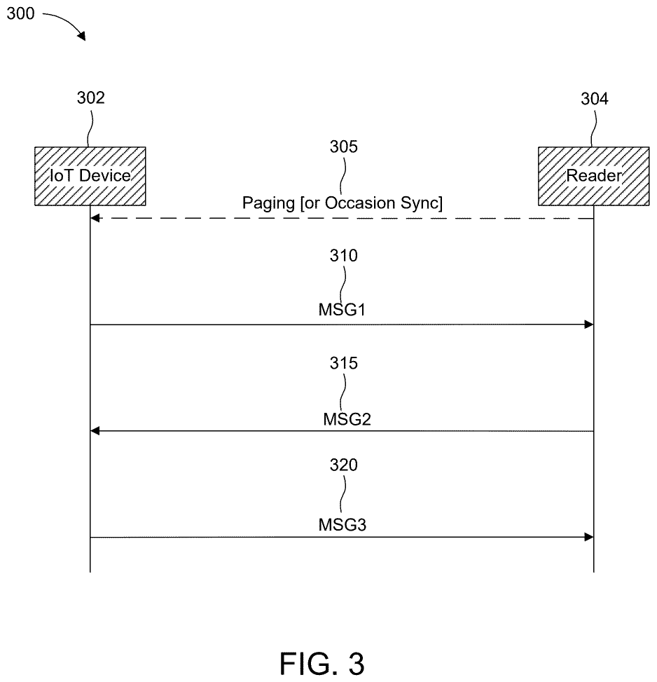

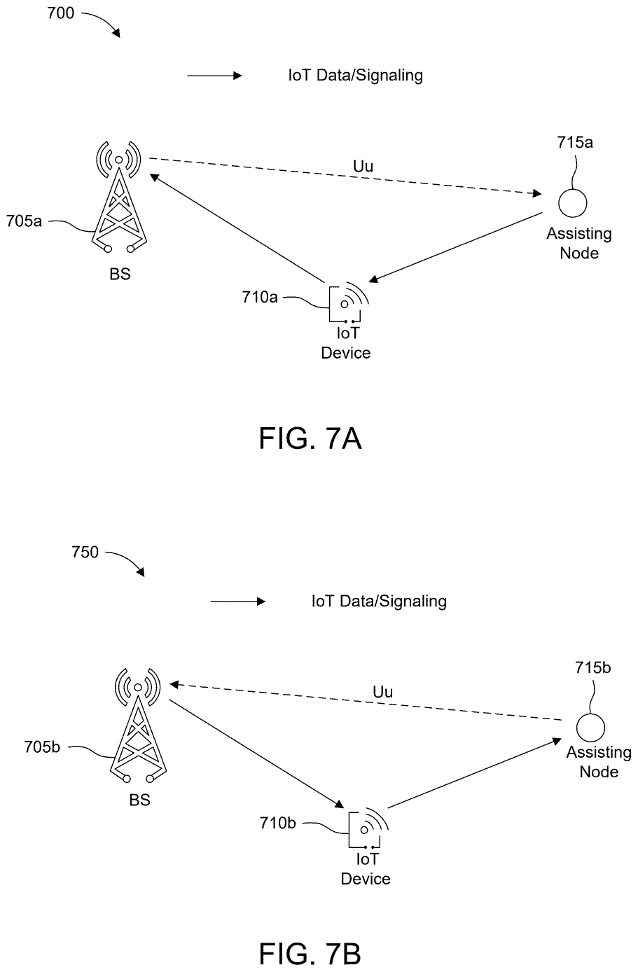

FIG. 3 illustrates an example IoT random access procedure 300, which may be used in combination with any of other embodiments described herein. The IoT random access procedure 300 may also be used for AIoT. For example, IoT devices may perform the IoT random access procedure 300 with a reader 304. As illustrated in FIG. 7, the reader 304 may send a paging message 305 and/or a set of occasion synchronization messages which respectively provides the device IDs of the devices to responds and configures/delimits the random-access occasions for transmissions by the IoT devices 302. An IoT device 302 may select an occasion (e.g., using at least slotted ALOHA as the baseline), and transmit a random device ID in MSG1 310. The reader 304, upon successful reception of MSG1 310, may transmit MSG2 315 by including the received random device ID in MSG2 315. If the IoT device 302 receives the echoed random device ID in MSG2 315, it may transmit MSG3 320 which may include device ID and/or application layer data (e.g., an application layer device ID). Although it is not shown in FIG. 3, MSG4 may be transmitted by the reader 304 (e.g., for subsequent command transmission), but the contention may already be resolved at MSG2 transmission.

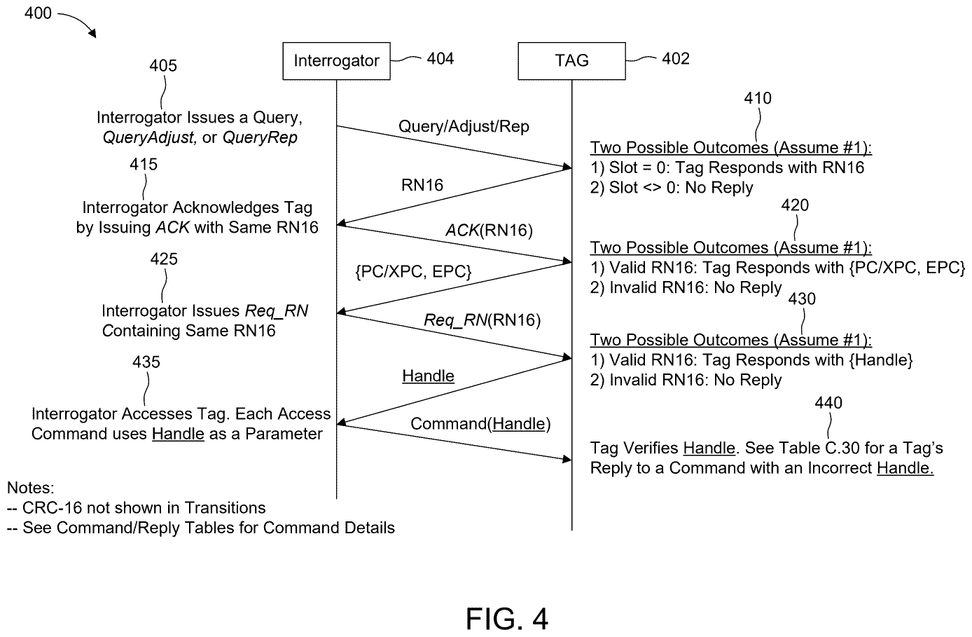

FIG. 4 illustrates an example inventory procedure 400, which may be used in combination with any of other embodiments described herein. The inventory procedure 400 may be an RFID inventory procedure. As illustrated in FIG. 4, at 405, a query message (or QueryAdjust, QueryRep) may initiate one round of the inventory procedure 400, and the query message including a parameter Q, which is used by the interrogator to regulate the probability of a device/tag response. Upon receiving a query message, a tag 402 (or device) may select its slot counter to a value between 0 and 2\hat{ }Q−1 derived from the parameter Q. The tag (or device) may decrement their slot counter every time upon receiving a QueryRep. When the tag's slot counter reaches zero, at 410, the tag 402 (or device) may transmit a 16 bit random number (e.g., RN16). On a condition that the slot counter equals 0, the tag 402 (or device) may sends an RN16 message to the interrogator 404. If the slot counter does not equal 0, the tag 402 (or device) does not send the RN16 message (e.g., does not reply to the interrogator 404). In response to the RN16 message, at 415, the interrogator 404 may acknowledge receiving the R16 message by sending an acknowledgement (ACK), including the same R16 received from the tag 402 (or device). On a condition that the ACK at 415 includes a valid RN16 (e.g., the same RN16 generated/transmitted by the tag 402 at step 410), at 420, the tag 402 (or device) may send a protocol control (PC)/extended protocol control (XPC), electronic product code (EPC) message. In one example, upon receiving the valid RN16, a tag 402 may transmit the tag's unique identity information (e.g., PC/XPC, EPC). Alternatively or additionally, on a condition that the ACK does not include a valid R16 (e.g., not the same RN16 generated/transmitted by tag at 410, the tag 402 does not send the PC/XPC, EPC message (e.g., does not reply to interrogator 404 at 420). In response to receiving the PC/XPC, EPC message, at 425, the interrogator 404 may send Req_RN message to the tag 402 (e.g., to check the successful reception of the PC/XPC EPC message at 420), including the same R16 as in the R16 message at 410 and ACK at 415. On a condition that the Req_RN message includes a valid R16, at 430, the tag 402 may send a handle to the interrogator 404. Alternatively or additionally, on a condition that the Req_RN message at 425 does not include a valid R16, the tag 402 does not send a handle to the interrogator 404 (e.g., does not reply to the interrogator 404). After receiving the handle, at 435, the interrogator 404 may have access to the tag 402, and can issue commands using the handle as a parameter. As shown in 435, the interrogator 404 may send a command message to the tag 402, which includes the handle as a parameter. At 440, the tag 402 may verify the handle before accepting the command.

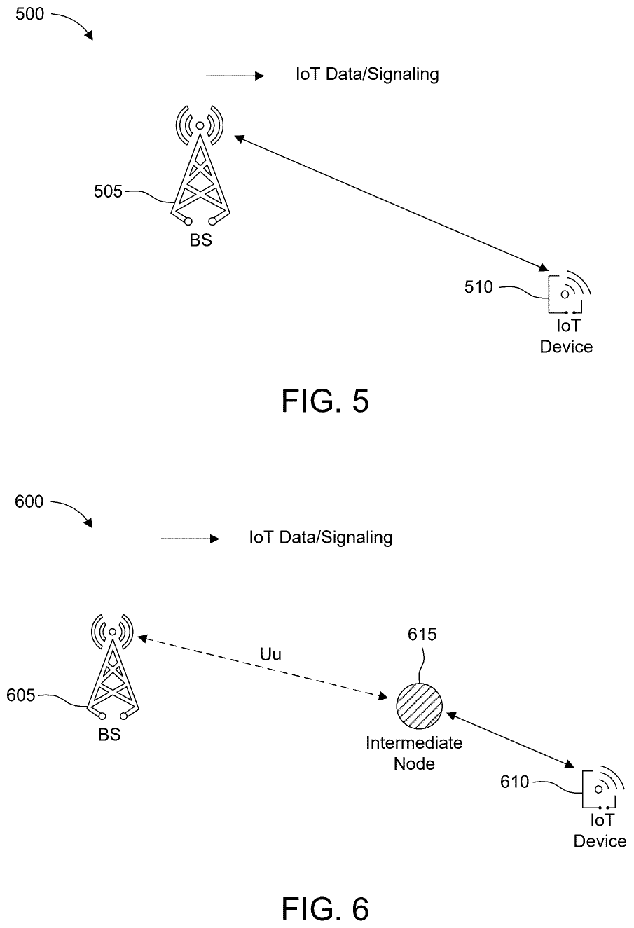

FIG. 5 illustrates an example topology 500, which may be used in combination with any of other embodiments described herein. As illustrated in FIG. 5, an IoT device 510 may directly and/or bidirectionally communicate with a base station (BS) 505. The IoT device 510 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the BS 505 and the IoT device 510 (e.g., ambient IoT device) may include IoT data and/or signaling (e.g., ambient IoT data and/or signaling). The topology 500 may include the possibility that the BS transmitting to the IoT device 510 is different from the BS receiving from the IoT device. In the topology 500, the BS 505 may be a reader, and the IoT device 310 may be a tag.

FIG. 6 illustrates an example topology 600, which may be used in combination with any of other embodiments described herein. As illustrated in FIG. 6, an IoT device 610 may communicate bidirectionally with an intermediate node 615 between the IoT device 610 and BS 605. The IoT device 610 may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topology 600, the intermediate node 615 may be a relay, an integrated access and backhaul (IAB) node, WTRU, UE, a repeater, or the like, which is capable of IoT communication. The intermediate node may transfer the information between the BS 605 and the IoT device 610. In the topology 600, the BS 605 and/or the intermedia node 615 (e.g., a relay or a repeater) may be a reader, and the IoT device 410 may be a tag.

FIG. 7A-B illustrate example topologies 700, 750, which may be used in combination with any of other embodiments described herein. As illustrated in FIG. 7A, an IoT device 710a may transmit data/signaling to a BS 705a and receive data/signaling from an assisting node 715a. As illustrated in FIG. 7B, an IoT device 710b may receive data/signaling from a BS 705b and transmit data/signaling to an assisting node 715b. The IoT devices 710a-b may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topologies 700, 750, the assisting nodes 715a-b may be a relay, IAB, WTRU, UE, a repeater, or the like, which is capable of IoT communication. In the topologies 700, 750, the BS 705a-b and/or the assisting node 715a-b (e.g., a repeater or a relay) may be a reader, and the IoT device 510a-b may be a tag.

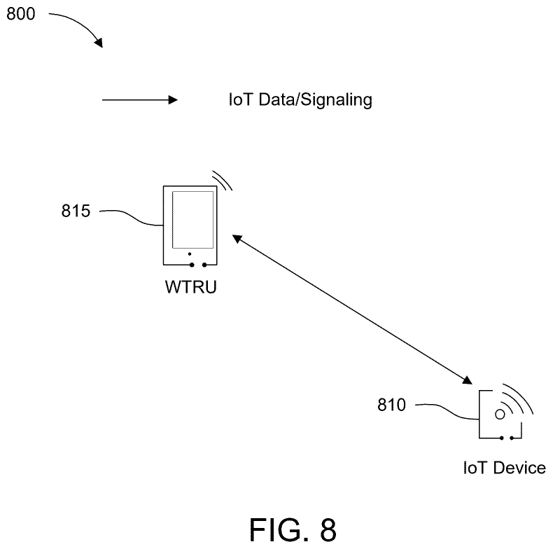

FIG. 8 illustrates an example topology 800, which may be used in combination with any of other embodiments described herein. As illustrated in FIG. 8, an IoT device 810 may communicate bidirectionally with a WTRU 815 (or UE). The IoT device 810 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the WTRU 815 and the IoT device 810 may include IoT data and/or signaling (e.g., ambient IoT data and/or signaling). In the topology 800, the WTRU 815 (or UE) may be a reader, and the IoT device 810 may be a tag.

Service for ambient IoT may comprise inventory only (e.g., access by a number of paged devices for them to report their upper layer device IDs), inventory+command (e.g., inventory followed by read/write access to a subset of the devices), and command only.

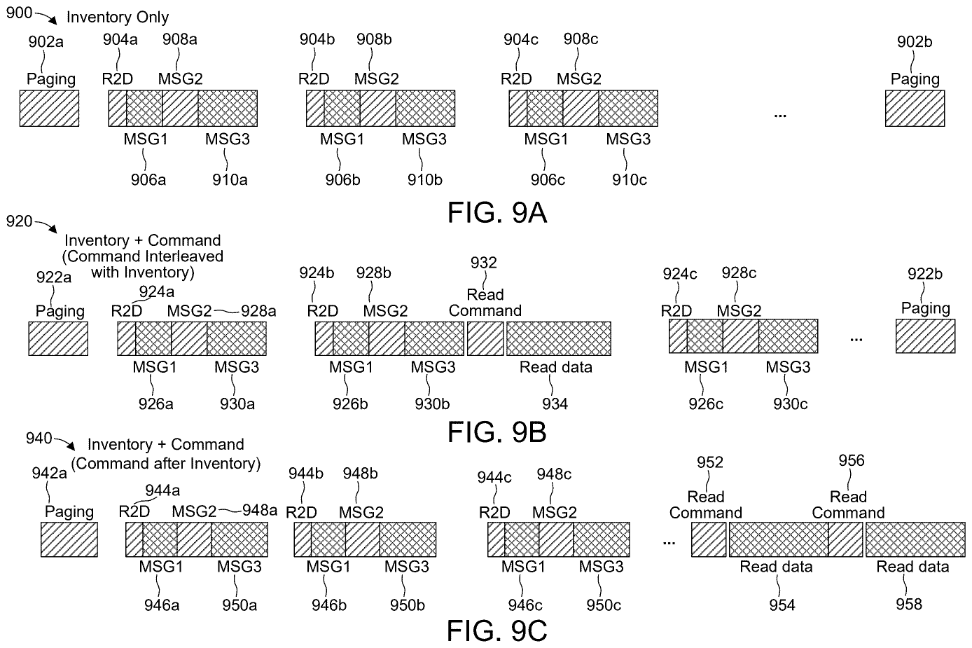

FIG. 9A illustrates an example resource allocation 900, which may be used in combination with any of other embodiments described herein. For the topology 600 illustrated in FIG. 6 where the network allocates resources to the intermediate WTRU (or intermediate UE) for the IoT service (e.g., AIoT service), inventory only may have regular resource allocation by the network to the intermediate WTRU. Based on the value of Q, the network may allocate all resources at once (e.g., using an RRC message) when the inventory is triggered as these resources can comprise a periodic set of resources between each resource associated with paging. As illustrated in FIG. 9A, each set/group of resources may comprise: (1) a resource 904a-c for an R2D message (e.g., sync or query rep that initiates an occasion); (2) a resource 906a-c for MSG1 transmission by a device in an occasion; (3) a resource 908a-c for MSG2 transmission by the reader, and (4) a resource 910a-c for MSG4 transmission by the device. A set/group of resources may also include a resource 902a-b for paging. The resources 906a-c, 910a-c for MSG 1 and MSG 3 may correspond to D2R transmissions, and the resources 902a-b, 904a-c, 908a-c for paging, R2D messages, and MSG2 may correspond to R2D transmissions.

FIG. 9B and FIG. 9C illustrate example resource allocations 920, 940, which may be used in combination with any of other embodiments described herein. Inventory+command will require additional resources for transmission of the command by the reader, and possibly reception of the data to be read from the device. Such resources may be interleaved with the inventory procedure or may be included at the end of the inventory procedure. FIG. 9B and FIG. 9C illustrates two resource allocation approaches. As illustrated in FIG. 9B, a resource 922a-b may be dedicated for paging messages. A set/group of resources 924a, 924c, 926a, 926c, 928a, 928c, 930a, 930c in an access occasion may be dedicated for R2D, MSG1 MSG2, and MSG3 messages. Another set/group of resources 924b, 926b, 928b, 930b, 932, 934 in another access occasion may be dedicated for R2D, MSG1 MSG2, MSG3, and one or more command transmissions and data reception. As illustrated in FIG. 9C, a resource 942a may be dedicated for a paging message. A set/group of resources 924a-c, 926a-c, 928a-c, 930a-c in an access occasion may be dedicated for R2D, MSG1 MSG2, and MSG3 messages. Another set/group of resources 952, 954, 956, 958 in another access occasion may be dedicated for one or more command transmissions and data receptions.

The two approaches illustrated in FIG. 9B and FIG. 9C may be taken based on reader complexity and device complexity. Since the number of devices which respond (and which occasion each device responds in) may not be known a-priori, the approach illustrated in FIG. 9B, where the commands are transmitted at the end of the inventory is preferable from an intermediate WTRU and network perspective (e.g., resources for command can be allocated once all of the commands to be issued are known.) However, this approach may be infeasible for the IoT device (e.g., AIoT device). Specifically, a device can be assigned an AS layer identification upon completion of IoT random access that is used to address the device for commands. This may require the device to maintain its AS layer identification for a long period of time, which would consume energy (e.g., for storage of the identification). In addition, following inventory, it is preferable if a device completes pending read/write operations as soon as possible in order to avoid monitoring for additional messages to wait for its command time.

Given that the focus of IoT (or AIoT) is on reducing device complexity, support for the command interleaved with the inventory may be preferred. However, the network may not know at the beginning of the inventory, which occasions require such resources, as this is dependent on when specific devices decide to respond to the paging. When inventory is interleaved with command procedure, the need of IoT (or AIoT) resources will depend on the sequence/order of the devices that respond to the inventory and if they have a command pending (as well as the type of command). Thus, methods and apparatuses for how the intermediate WTRU obtains resources as well as schedule the commands (e.g., to reduce the device power consumption, but avoid excessive Uu signaling) are needed. Furthermore, different from RFID where the command is always issued immediately following access by the device, the flexibility of issuing a command for IoT (or AIoT) in a different occasion may be preferable for the topology 600 illustrated in FIG. 6.

Embodiments for how an intermediate WTRU obtains resources for and schedules commands to AIoT devices are disclosed herein, considering that neither the intermediate WTRU nor the network know the timing (e.g., the access occasion) where each device will succeed IoT (or AIoT) access procedure.

The terms device, IoT device, AIoT device, IoT UE, AIoT UE, IoT WTRU, AIoT WTRU, and tag may be used interchangeably throughout this disclosure to mean an IoT device that is being inventoried/queried by a reader.

The term reader may refer to the entity which queries the IoT device, either directly, or via an intermediate node. The term reader may also refer to the intermediate node 615 in FIG. 6. As a result, the term reader may refer to a network node, a WTRU or a UE that queries the IoT device, depending on the context and/or the topology. For example, in FIG. 5, the BS 505 may be a reader that queries the IoT device 510. The terms reader, network, network node, intermediate node, assisting node, intermediate UE, assisting UE, intermediate WTRU, and assisting WTRU may be used interchangeably throughout this disclosure.

The term inventory (or inventory procedure) may refer to the overall procedure of a reader triggering access by multiple IoT devices using a sequence of messages (e.g., similar to the query, followed by QueryRep 220a-d in FIG. 2). Specifically, the inventory procedure may refer to a single round of attempts to have each IoT device respond or attempt to respond with its access ID or perform a RACH procedure. Specifically, the inventory procedure may refer to a set of access occasions which may have 0 or at least 1 IoT device respond within the access occasion. The inventory procedure may occur similarly to the legacy RFID procedure. The term inventory procedure may be used interchangeably with a paging procedure, a query procedure, or the like, depending on IoT device requirements and/or specifications.

The term command may refer to the overall a command procedure which is triggered by a WTRU (e.g., reader) for one or more devices after inventory procedure is completed (e.g., RACH procedure and/paging/query procedure). For example, a WTRU may trigger a command procedure for one or more WTRUs after when the one or more WTRUs complete the inventory procedure. For example, the WTRU may perform data communication with the device(s) via the IoT or AIoT interface during a command procedure. For example, the WTRU may send a command with an operation request (e.g., read, write, or the like) with one or more devices. For example, a read command is that a WTRU allows to read (all/a part of/portion of) device information (e.g., memory, EPC memory, TID memory, or the like). For example, the write command is that the reader allows to write a word and/or information in a device's memory (e.g., memory, EPC memory, TID memory, or the like). For example, the command may be a “read” command wherein the device1 802 is expected to read the data from a memory location and the response to the command may be the data the device reads from the memory location. In another example, the command may be a “write” command and the response may be an acknowledgement. The command may have associated information (e.g., information/data associated with the command) or associated control information to be sent/configured/indicated by the reader. For example, a “read” command may be associated with the information of an address of a memory location the device is expected to read. For example, a “write” command may be associated with the information of an address for a memory location and the data to write to that memory location. The command and the associated information (or associated control information) may be sent to the device.

The command may comprise general IoT commands, AIoT commands, and RFID commands. Examples of the general IoT commands may include, but are not limited to, device configuration commands, and connectivity commands. The device configuration commands may include a “configured device” command, a “firmware update” command, a “factory rest” command. The connectivity commands may include a “connect to network” command, a “ping device” command. Examples of the AIoT commands may include, but are not limited to, data commands, device control commands, communication and protocol commands, and AI specific commands. The data commands may include a “data ingestion” command, a “data processing” command, and a “data retrieval” command. The data control commands may include a “device discovery” command, a “command and control” command, and an “AI model update” command. The communication and protocol commands may include a “MQTT publish/subscribe” command, and “HTTP/REST API calls” command. The AI specific commands may include a “inferencing” command, and a “train AI model” command. The RFID commands may include, but are not limited to, read commands, write commands, and tag access commands. The read commands may include a “read tag data” command, an “inventory” command, and a “read memory bank” command. The write commands may include a “write tag data” command, a “lock/unlock tag” command, and a “kill” command. The tag access commands may include an “authenticate” command, and a “read access permissions” command.

The term occasion may refer to the opportunity for IoT device transmission that may be delimited by the transmission of a query rep message (or similar). Specifically, an IoT device may perform transmission in an occasion by performing an IoT transmission in a defined time following the QueryRep message associated with that transmission. Alternatively or additionally, an occasion may include both a time aspect and a frequency aspect. Specifically, an IoT device may determine an occasion as a transmission following a specific QueryRep message, and by transmitting on one of a number of frequencies (e.g., FDM). Throughout this disclosure, the selection of an occasion may be applied equivalently to a selection of only a time component and/or the selection of a frequency component.

An IoT or AIoT transaction herein may comprise any of an inventory procedure, an inventory+command procedure, a command procedure, or a random access procedure, in the context of IoT or AIoT.

Throughout this disclosure, any reference to time may be associated with an absolute time measurement (e.g., seconds, slots, frames, etc.). Alternatively or additionally, it may refer to a number of executions of a procedure, possibly triggered by a reader (e.g., number of inventory procedures, number of accesses or RACH procedures, etc.). Alternatively or additionally, it may refer to a number of messages, for example, of a specific type, or including specific information received or transmitted.

Configuration or pre-configuration may refer to any configuration received by a message or prestored in an IoT device or a network node. Examples of the message may include, but are not limited to, an RRC message, a MAC CE, a PHY layer signal, a data PDU, and a control PDU associated with any or a new protocol layer. These messages may be received from either a network node or from another device (e.g., WTRU or UE).

A device (or IoT device) described herein may be configured by a reader. The reader may be a network node, a WTRU, or a UE (e.g., intermediate node 615 in FIG. 6). In the case of a WTRU or UE, the WTUR or UE may derive the IoT device configuration itself, or receive the IoT device configuration from the network. In this case, the IoT device configuration may be relayed from the network to the IoT device by the WTRU or UE. On the other hand, a WTUR or UE configuration (e.g., in the case that the WTRU or UE is the intermediate node 615 in FIG. 6) may be received from a network node (e.g., the gNB or BS 605 in FIG. 6).

The term resource (e.g., when referring to the IoT interface) may refer to at least any of one or more time/frequency resources, one or more frequency resources which may be available at different times, one or more time resources, a single time/frequency resource repeated with a periodicity, and/or multiple frequency resources over a single time slot or multiple time slots. For example, the one or more time/frequency resources may be one or more consecutive time/frequency resources. For example, the one or more time/frequency resources may be one or more non-consecutive time/frequency resources. For example, the time resource may be limited to one or more frequencies or frequency ranges. The time resource may start from the transmission of a reader message, and last either a maximum period of time, or until the next transmission by the reader, possibly of a specific message.

In some embodiments, the network may require the WTRU to send a resource and/or service request to the network to obtain resources for IoT or AIoT transmission/reception. Such may be examples whereby a BS (e.g., gNB) is transparent to the specifics of the IoT or AIoT service sent to the WTRU. For example, if the WTRU receives an IoT or AIoT service (e.g., inventory request) from the CN via NAS or data layer, the network may not be aware of the details of such service request. The WTRU may then transmit information about the service request to the BS (e.g., gNB) to obtain the required resources.

A WTRU may be configured with Uu resources which can serve the purpose of performing transmissions to IoT or AIOT devices. Such resources may also serve for the reception of transmissions by the IoT or AIOT devices to the reader WTRU. The devices may be informed of the resources that they may use for transmission by the WTRU reader (e.g., in the WTRU reader transmissions themselves).

In some embodiments, the resource configuration may be provided to the WTRU following a resource request. Specifically, the WTRU may transmit the resource request after reception of a service request.

In other embodiments, the resource configuration may be provided to the WTRU along with the service request. Specifically, in architectures where the BS (e.g., gNB) is controlling the IoT or AIoT service, the BS (e.g., gNB) may provide the IoT or AIoT resources along with the service request.

A resource for a specific transmission by the device or by the reader may comprise a time-frequency resource, including one or more slots, defined over a single or multiple resource blocks in frequency. For example, some resources assigned to the reader, possibly for a specific transmission or reception type, may comprise a single slot resource. Alternatively or additionally, some resources assigned to the reader, for example, for a specific transmission or reception type, may comprise multiple slot resource. The reader may decide, based on one or more factors described herein, whether to use a single slot, multiple slots, the number of slots, or the like.

A reader may receive a list of resources associated to a specific transmission/reception type or purpose. In one example, the resource configuration provided by the network may identify (e.g., implicitly or explicitly) the allowed purpose of each resource in terms of IoT or AIoT operation. Specifically, a resource may be dedicated for at least one of or any of a combination of: transmission by the reader; transmission by a device (i.e., expected reception by the reader); transmission, by the reader, of a specific type of message on IoT or AIoT; or transmission, by the device, of a specific type of message on AIOT. The transmission, by the reader, of a specific type of message on IoT or AIoT, for example, may comprise a paging message, command transmission, command transmission of a specific type (e.g., read command, write command, or the like), MSG2 transmission, sync/R2D/occasion start message, data or segment of data, and/or the like. The transmission, by the device, of a specific type of message on IoT or AIoT, may comprise, for example, MSG1 transmission, MSG3 transmission, command response transmission, command response transmission of a specific type (e.g., response to a read command, or a write command), data or segment of data, and/or the like.

Resource configuration may be provided in a message such as a NAS message or an RRC configuration message to the reader. In case that resources are associated with IoT or AIoT transmission, this association may be provided explicitly, for example, by indicating a resource type or purpose (e.g., indicating the purposes above) in the message (e.g., RRC message) along with each time/frequency resource. For example, a resource configuration may comprise a list of time-frequency resources (e.g., where each resource may possibly be a periodic resource, where each resource may possibly be a recurring resource valid for a period of time), where each time/frequency resource in the list has a corresponding resource type field (e.g., one of {paging, command, read command, MSG2, and/or the like}). For example, a resource configuration for a specific type may be provided in a separate RRC message, or a separate IE. Specifically, a paging RRC message or IE may provide all resources for transmission of paging messages. Specifically, the RRC message or IE may be explicitly identified with the resource or operation type.

Alternatively or additionally, the resource configuration may implicitly define the association to the purpose. Such implicit association may be based on at least one of or one or a combination of: time and/or frequency order and/or location of the resources; size of the resources; and/or periodicity and/or distance between repetitive resources of the same size.

Time and/or frequency order and/or location of the resources may possibly be relative to other IoT or AIOT resources, or other Uu resources. Specifically, this may comprise any of the following relations: absolute time location (slot number, frame number, or the like) of a resource; absolute frequency location (e.g., RB index, carrier index, or the like) of a resource; specific resource instance or resource element in a list of resource instances (e.g., the first instance, the Nth instance, the last instance, or the like) or resource elements; and/or a time location relative to another IoT or AIoT resource, another Uu resource (e.g., DL or UL grant), a synchronization signal or reference signal (e.g., SSB, CSI-RS, or the like), system information (e.g., relative to MIB location, SIB location, or the like). For the specific resource instance or resource element in a list of resource instances (e.g., the first instance, the Nth instance, the last instance, or the like) or resource elements, each resource instance or resource element may include, but is not limited to: a set of time (slot) and/or frequency (RB) consecutive resources; and a set of time and/or frequency resources which are separated in time and/or frequency by at most X slots and/or Y RBs.

For example, the first resource in a resource configuration provided by the network may be associated with paging transmission.

For example, a resource which occurs in a timeslot immediately following a resource determined to be for transmission of a paging message and/or an occasion start message may be associated with a resource for MSG1 transmission. For example, a resource associated with a specific transmission type or purpose may have a predefined, specified, or configured condition on the slot number, frame number, RB number, and/or the like. For example, resources provided within a range of configured slot and/or frame numbers are assumed to be for paging transmission. For example, resources configured with a slot number divisible by X are assumed to be for transmission of a specific message type. For example, a resource configured for IoT or AIoT which occurs in the slot following a Uu transmission by the WTRU (e.g., a Uu grant) may be assumed to be for transmission by the reader, possibly of a specific type. For example, a resource which occurs within a (e.g., maximum/minimum) time period from a Uu grant may be assumed to be for transmission by the reader, possibly of a specific type. For example, a resource which occurs (at most, at least, and/or exactly) X slots after another resource, where another resource may be of a specific size, determined for a specific message type, or associated with some other property herein, may be associated by the reader as a resource usable for MSG2 transmission. For example, a resource which occurs in the same RB or set of consecutive RBs as a resource for MSG1, possibly having a specific size (as per herein), possibly located a specific time after the MSG1 resources, may be associated with MSG3 message transmission

As described above, the implicit association may be based on the size of the resources, possibly in terms of time consecutive slots and/or frequency consecutive resource blocks. For example, a configured resource of a specific size, not larger than a specific size, not smaller than a specific size, may be determined by the reader to be used for a specific purpose. The specific size may be a predefined or specified size, a configured size (e.g., in RRC signaling or from the CN and/or upper layers of the WTRU) or may be computed by the WTRU using a combination of other factors herein. For example, a resource which is at most X slots over at most Y resource blocks may be associated by the reader as a resource usable for paging transmission. For example, a resource which is at least X slots, possibly over at least Y resource blocks may be associated by the reader as a resource usable for write command transmission. For example, a resource which is at most X slots over at most Y resource blocks.

As described above, the implicit association may be based on the periodicity and/or distance between repetitive resources of the same size (e.g., number of consecutive slots, number of consecutive resource blocks, or the like). For example, a configured grant with a periodicity of at least X slots or milliseconds may be associated with transmission of a paging message. For example, if the configured resources contain at least X time/frequency resources (e.g., possibly of a specific size in terms of consecutive slots/radio blocks) of the same size, and/or separated by at least a number of slots, each of these resources may be associated with sync or occasion start message by the reader.

Based on the above association, a reader may determine which resource to use for transmission or reception of a specific IoT or AIoT message. For example, a reader may transmit a paging message only in a resource identified for paging message transmission. For example, a reader may transmit MSG2 only in resources identified for MSG2 transmission.

Similarly, a reader may provide resource configuration for device transmission by selecting from the subset of resources associated with device transmission. For example, the reader may signal a set of resources for device transmission of MSG1 in paging, where the signaled resources are selecting from the resources indicated by the network (per above) for MSG1 transmission.

A reader may receive a set of usable resources and determine the specific transmission/reception type or purpose. In one embodiment, a reader may be provided with a set or a pool of resources, possibly occurring periodically, possibly valid for a specific period of time, whereby the reader may decide on its own the use of each of the resources on the IoT or AIoT interface. Specifically, the reader may make its own decision as per the use of a slot or set of slots (e.g., used for transmission of paging, used for transmission of MSG2, and/or the like).

The reader may perform such a decision for an inventory or IoT (or AIoT) operation at the onset of the operation (e.g., upon reception of the operation initiation). For example, the reader may determine the time/frequency resources associated with each IoT (or AIoT) transmission or reception (e.g., paging transmission, MSG1 transmission, occasion sync message, and/or the like) for the entire operation (e.g., an inventory procedure) at one time, and may transmit information about the subsequent resources in the paging messages to the devices.

Alternatively or additionally, the reader may determine the use of and/or the usage/non-usage of a resource dynamically. For example, for each IoT or AIoT transmission and/or reception, a reader may determine whether the next upcoming resources allocated in the next slot or set of slots is to be used for the IoT or AIoT transmission and/or reception. If the reader decides to use the resource, it may perform the said transmission/reception in the said resource(s). If the reader decides not to use the next resource or set of resources, the reader may perform one of the actions described herein. Furthermore, rules or conditions described in this section may be used by the reader to decide whether to use the resource or not for the upcoming IoT or AIoT transmission and/or reception.

The reader may follow specific rules in the selection of such resources or decision for usage/non-usage. For example, a reader may select a resource or set of resources associated with paging transmission or retransmission, based on certain rules or restrictions. For example, a reader may select a set of resources for transmission of the access occasion start message, based on certain rules or restrictions. These rules may be based on the same factors for implicit determination of the resource purpose based on configuration.

Similarly, the reader may make a decision regarding the usage/non-usage of a configured resource based on similar rules or factors. Specifically, the reader may decide whether it can use a resource configured by the network based on such rules or factors. In one example, a reader may select resources for transmission/reception of a specific IoT or AIoT message. Following the selection of sufficient resources for the IoT or AIoT procedure, the reader may determine all additional configured resources to be unused resources. The reader may perform operations associated with unused resources described herein. Alternatively or additionally, the reader may decide whether to use the next upcoming resource for transmission of the occasion sync message following reception of MSG1, or not to use the resource.

For example, for reader transmission, the reader may use rules herein to determine whether to use a resource to transmit a R2D message. For example, for device transmission, the reader may use rules herein to determine whether to schedule the resource to the device for D2R transmission (i.e., whether to send the scheduling information in a previous R2D transmission). When deciding not to use a resource, the reader may not use either resource, for example, the one associated with R2D transmission of the scheduling information, or the one associated with D2R transmission in the resource indicated by the scheduling information. Alternatively or additionally, the reader may send alternative scheduling information (of another resource) in the R2D message for the device to be used.

A reader may follow specific rules for selecting resources for IoT or AIoT transactions (e.g., transmissions or receptions) and/or determination of usage/non-usage of resources. Such rules may be based on one or more factors: time and/or frequency order and/or location of the resources; size of the resources; periodicity and/or distance between repetitive resources of the same size; received signal strength of a previous transmission by a device; device type or device capabilities of the device to which the transmission/reception in the resource is intended; information about the upper layer message size to transmit; information received from a device transmission; or determined or decided transport block size for a particular resource and/or the coding rate.

The time and/or frequency order and/or location of the resources may possibly be relative to other IoT or AIoT resources, or other Uu resources. Specifically, the reader may use similar rules as described above (e.g., rules where a reader receives a list of resources associated with a specific transmission/reception type or purpose) for the selection of resources and/or determination of usage/non-usage.

For example, the reader may decide to use or not use two subsequent resources based on the time between them. For example, based on whether the time between the end of the first resource and the start of the second resource is larger or smaller than a threshold, based on whether the time between the end of the first resource and the start of the second resource is larger or smaller than a threshold, based on whether the time between the start of the first resource and the end of the second resource is later than a threshold. Such threshold may be predefined or configured by the network. Such threshold may be derived from information received from the device (e.g., a threshold associated with a device type, a value transmitted by the device itself, and/or the like). Such threshold may be received from the core network, possible as part of the IoT or AIoT operation information.

For example, the reader may need to transmit an occasion sync message or paging message, possibly in an upcoming resource. The reader may decide to use the resource for transmission of the occasion sync message or paging message if the time between the end of the resource for sync message/paging message transmission, and the start of a subsequent resource (which the reader may associate with transmission of MSG1) is at larger than a first threshold and/or at smaller than a second threshold. The motivation may be for the reader to select or use resources which respect the devices' reception to transmission delays.

For example, the reader may need to retransmit an R2D message which schedules a D2R message. If the upcoming resource available for transmission of the R2D message occurs at least a threshold time since the last D2R transmission, possibly associated with that specific device, the reader may use the resource for the R2D message. Otherwise, it may not use the resource.

The size of the resources may possibly be determined in terms of time consecutive slots and/or frequency consecutive resource blocks. Specifically, the reader may use similar rules as described above (e.g., rules where a reader receives a list of resources associated to a specific transmission/reception type or purpose) for the selection of resources and/or determination of usage/non-usage.

For example, the reader may select (or use) a resource for a specific R2D transmission (e.g., a read command transmission) if the resource is at least X slots in length, where X may be predefined, configured, determined from information received from the device and/or the network (e.g., device type, read command type), determined from the measured RSRP of a device transmission, associated with the code rate of the transmission, and/or the like.

For example, the reader may select (or use) a resource for MSG1 reception (e.g., possibly in conjunction with the previous R2D transmission) if the number of RBs (or the frequency size) of the resources for MSG1 transmission is larger than a threshold. Such threshold may be predefined, configured, or determined based on information from the device (e.g., device capability), information received from the CN (e.g., the device types of the devices that will perform inventory).

The periodicity and/or distance between repetitive resources of the same size, for example, may be a number of consecutive slots, a number of consecutive resource blocks, and/or the like. Specifically, the reader may use similar rules as described above (e.g., rules where a reader receives a list of resources associated with a specific transmission/reception type or purpose) for the selection of resources and/or determination of usage/non-usage.

The received signal strength of a previous transmission by a device may be used to determine the rules for the selection of resources. For example, the reader may select or use a resource for an R2D transmission if the received RSRP of the previous D2R transmission, possibly associated with the same device, is above a threshold.

The device type or device capabilities of the device to which the transmission/reception in the resource is intended may be used to determine the rules for the selection of resources. For example, the reader may select or use a resource for an R2D transmission, for example, possibly to a specific device, if the device has a specific type or capability.

The information about the upper layer message size to transmit may be used to determine the rules for the selection of resources. For example, the reader may select or use a resource for an R2D transmission (e.g., a command message) if the received message size associated with the command message, or the command response, is below a threshold, possibly where such threshold is derived from the size of the resource or type of the resource itself.

The information received from a device transmission, possibly being the device to which subsequent resources will be used for transmission to that device, may be used to determine the rules for selection of resources. For example, a device may transmit an indication that it has run out of energy. The reader, upon reception of such an indication, may decide not to use any configured resources, possibly for transmission to that specific device, possibly for a configured period of time after reception of the indication.

The determined or decided transport block size for a particular resource and/or the coding rate may be used to determine the rules for selection of resources. For write command transmission, for example, the reader may compute (e.g., based on the received RSRP associated with a device transmission) a coding rate, and correspondingly a transport block size usable for transmission in a resource configured by the network. The reader may decide to utilize the resource for transmission to the device if the message size (e.g., a write command) is smaller than or equal to the transport block size. For read command reception, for example, the reader may compute (e.g., based on the received RSRP associated with a device transmission) a coding rate, and correspondingly a transport block size usable for transmission by the device in a resource configured by the network. The reader may decide to schedule such resource to a device in a transmission if the message size (e.g., the expected response of a read command) is smaller than or equal to the transport block size.

For paging message transmission, for example, the reader may be (pre)configured with a coding rate for a given paging message transmission. For example, a reader may increase the coding rate for each subsequent retransmission of the same paging message (i.e., the paging message associated with the same service request from the core network). For example, the reader may retransmit a paging message until it receives a threshold number of total devices responding to a specific service request, or until the number of retransmissions reaches a threshold number. At each paging retransmission, the reader may increase the coding rate of the paging message, thus increasing the required resource size (e.g., consecutive number of slots and/or frequency blocks) for transmission of a single paging message. At each paging transmission, the reader may determine whether an upcoming (or in sequence) resource configured for IoT or AIoT is large enough to transmit the paging message for that retransmission iteration. If it is, the reader may use the resource. Otherwise, it may skip the resource, or indicate non-usage, as described herein.

Combinations of the above conditions or factors may be used in the decision to select or whether to use resources. For example, the condition may be determined using a first factor and the threshold may be determined using a second factor. For example, a combination (AND/OR) of conditions may be used. For example, a condition may be checked only if another condition is satisfied.

In one example, inventory only scheduling may use a set of resources determined by the reader. A reader may trigger an inventory only procedure following reception of a set of resources from the network. The reader may select/use the first resource in time to transmit the paging message. Depending on the size of the paging message (e.g., the number of device IDs in the paging message), the reader may use a single slot or multiple slots for transmission of the paging message. If a number of consecutive slots are available in the first resource for transmission of the paging message, the reader may use the first resource. Otherwise, it may select the first multi-slot resource available for transmission of the paging message and indicate the other resources are unused.

The reader may then select a number N of resource quadruplets: a first resource for sync message transmission which is large enough for transmission of the R2D sync message; a second resource for MSG1 reception; a third resource for MSG2 transmission; and/or a fourth resource for MSG3 reception from the device. Alternatively or additionally, the reader may be assigned such resources by the network implicitly or explicitly, as described herein.

The reader may determine the required message size based on a preconfigured or predefined message size for each of the above messages. Alternatively or additionally, the reader may determine the coding based on the provided resource size from the network (e.g., assuming that each successive resource in the received resource configuration from the network is explicitly or implicitly associated with each of the above messages in sequence).

Following the selection of the N quadruplets, the reader may perform transmission of the R2D sync message in the first resource of the quadruplet. The reader may receive on the resources for MSG1. If the reader receives at least one WTRU ID (or UE ID) on (one of) the MSG1 resources, the reader may echo that WTRU ID on the third resource of the quadruplet (e.g., for MSG2). If the reader does not receive at least one WTRU ID on (one of) the MSG1 resources, the reader may perform any or a combination of the following:

The reader may send an indication to the network of a resource modification. For example, the indication of the resource modification may be followed by a reconfiguration by the network of the resources. The reader may suspend transmission on AIOT interface until reception of the new resources. In another example, the indication of the resource modification may be followed by an acknowledgement by the network. The reader may change from one preconfigured resource configuration to another upon reception of the acknowledgement. For example, the new configuration may change the timing of the subsequent quadruplets. For example, the new configuration may change the resource size of the subsequent resources, so that MSG2 and MSG3 resources can be reused for sync and MSG1 transmission. The reader may suspend AIOT message transmission until reception of the acknowledgement from the network; and/or

The reader may send an indication of resource non-usage to the network. For example, the reader may indicate the resources for MSG2 and MSG3 are unused. The reader may continue the inventory on the set of resources associated with the next quadruplet (i.e., the next access occasion) without the need to change any of the resources associated with the next quadruplet. Non-usage indication allows the network to reallocate the resources initially allocated for MSG2 and MSG3 transmissions to other WTRUs.

Following the selection of the N quadruplets, the reader may receive on the resources for MSG3. If the reader correctly decodes a device transmission on the MSG3 resource, it may continue the inventory in the next access occasion. The received data on the MSG3 resource may be sent to the network (immediately or in a later Uu transmission). If the reader does not correctly decode the device transmission on MSG3 resource, the reader may transmit a modification request to the network. In this case, the reader may be reconfigured with a new sequence of resources whereby an additional resource for R2D indication to the device to repeat MSG3 transmission, as well as an additional resource for MSG3 transmission are provided immediately, possibly without a change of subsequent quadruplets, possibly with a change of the timing of subsequent quadruplets.

If the reader does not correctly decode the device transmission on MSG3 resource, the reader may transmit a non-usage request to the network. In this case, the reader may not use the resources for sync transmission and MSG1 reception in the next quadruplet, thus indicating such to the network. The reader may initiate a retransmission of MSG3 by the device by transmitting MSG2 again (e.g., the same WTRU ID) in the resource for MSG2 in the next quadruplet, and receive the MSG3 transmission in the MSG3 resource in the next quadruplet. In this case, in other words, the resources for an access occasion are repurposed for the retransmission of MSG3, with the exception that the R2D sync message resource and the MSG1 resource are unused (and therefore the reader indicates this to the network). The reader may transmit the non-usage request without the need to wait for an acknowledgement message.

A reader may select/determine the resources it uses and indicate them to the network. In one embodiment, a reader may select its own resources from the set of all resources (or a subset of resources) on a Uu carrier. A reader may perform such selection upon initiation of an IoT or AIoT procedure (e.g., request from the network). The reader may provide the selected resource configuration (e.g., the list of all resources selected) to the network prior to or at initiation of the IoT or AIoT procedure.

A reader may be provided, by the network, with a restriction associated with resource selection. Such restriction may be based on one or more of: a time restriction; a restriction on frequency range; a set of unusable resources; an (absolute) amount of time/frequency resources; or a restriction or relation relative to allocated Uu resources.

Embodiments for the determination of non-usage or modification are described herein. A reader may be configured with resources/messages to indicate non-usage or modification of a resource allocation to the network. In one example, a reader may be configured with dedicated Uu resources and/or Uu messages for indicating non-usage or modification of a resource allocation to the network. Such resources may be in the form of any of the following: dedicated SR resources; dedicated RACH resources; Uu MAC CE; an RRC message or IE within an RRC message (e.g., a cause value in a resume request); and/or any combination thereof. For the dedicated SR resources, for example, a WTRU may be configured with an SR resource used to indicate non-usage of one or more resources as described below. For example, a WTRU may trigger transmission of a dedicated SR, and then transmit a MAC CE with the details of the non-usage or modification. For the dedicated RACH resources, for example, a WTRU may be configured with dedicated RACH preambles to indicate non-usage or modification, or the desire to indicate such to the network. Such resources may be in the form of a combination of the above. For example, a WTRU may transmit the intention to indicate the non-usage or modification using one mechanism and may transmit the details of the modification using another mechanism.

A reader may indicate non-usage to the network. In one example, a reader may send an indication of resource non-usage to the network using one of the Uu resources described above. The reader may indicate resource non-usage to the network upon one or more of the following events:
MSG1 is received from at least one device on at least one of the resources configured in an access occasion for MSG1 reception;
MSG1 is not received from any device on any of the resources configured in an access occasion for MSG1 reception;
A D2R message (e.g., MSG3, command response) is either not received from a device which was scheduled to transmit in that resource or was decoding in error at the reader; and/or
The number of devices which respond to a paging message (e.g., in one of the occasions) is larger than a threshold (e.g., requiring the reader to release any subsequent resources for additional paging rounds).

A reader may continue to use the allocated or selected resources (e.g., aside from the resources which are unused based on the non-usage indication) without confirmation from the network. Specifically, the reader may transmit a non-usage indication without expectation of a response from the network.

The Uu resources for non-usage indication on Uu may be associated with one or more IoT or AIoT resources. Such association may be based on the specific resources on Uu. For example, a reader may be configured with a first SR resource to indicate non-usage of MSG2 and MSG3 resources in an occasion, and a second SR resource to indicate non-usage of sync message and MSG1 resources in an occasion.

Alternatively or additionally, the association may be based on the information sent in the non-usage indication. For example, the reader may send a first message to the network (e.g., in a MAC CE) in case of non-usage for MSG2 and MSG3 resources, and a second message to the network (e.g., in a MAC CE) in case of non-usage of sync and MSG1.

Non-usage indication may signal that a specific instance of a resource configuration (e.g., a set of consecutive slots or resource blocks that are intended for a single AIOT transmission or reception) is no longer needed. Alternatively or additionally, non-usage indication may signal the multiple related resource instances (e.g., an R2D transmission resource and the corresponding D2R transmission resource, the resources associated with command transmission and response, the resource associated with a specific or multiple access occasions, and/or the like) are no longer needed. Alternatively or additionally, non-usage indication may signal that a specific resource instance may be reduced in size. For example, an instance intended for the transmission or reception of a single AIOT message may be changed from X slots to X-Y slots.

A reader may indicate which of the non-usage indications it is signaling to the network (e.g., by including this information in the Uu transmission). For example, a MAC CE or RRC message transmitted for this purpose may comprise an indication of the resource being indicated as unused, and/or an indication of which resources are signaled as unused. Alternatively or additionally, different Uu resources (e.g., SR resources) may be reserved to signal different non-usage indications.

A reader may Indicate modification to the network. In one example, a reader may send an indication of resource modification to the network using one of the Uu resources described above. The reader may indicate resource modification upon one or more of the following events:
MSG1 is received from at least one device on at least one of the resources configured in an access occasion for MSG1 reception;
MSG1 is not received from any device on any of the resources configured in an access occasion for MSG1 reception;
A D2R message (e.g., MSG3, command response) is either not received from a device which was scheduled to transmit in that resource or was decoding in error at the reader; and/or
The number of devices which respond to a paging message (e.g., in one of the occasions) is smaller than a threshold (e.g., requiring the reader to request additional resources for another paging round).

Following transmission of the modification, the reader may continue to use the existing resources until confirmation is received from the network. Alternatively or additionally, the reader may suspend transmissions on IoT or AIoT until reception of a reconfiguration from the network, or a confirmation of reception of the modification from the network.

Reader indication of modification may take one of the following forms. In one form, the reader may select from one of a list of predefined or configured resource transformations relative to the provided configuration (e.g., delay by a number of slots, advance by a number of slots, increase the number of command resources, decrease the number of command resources, add quadruplets to the end of the resources for the inventory, and/or the like). The indication may signal the modification selected by the reader. In another form, the reader may signal the change from one resource configuration to another. For example, the reader may be configured with a list of resource configurations. The reader may initiate an IoT or AIoT operation with a first resource configuration. Upon any of the triggers listed above, the WTRU may initiate a modification indication to the network and signal that it wishes to use the next resource configuration in the list or may indicate one of the resource configurations which it wants to use.

In another form, the reader may request additional resources in the modification. Specifically, the reader may request additional resources occurring within an access occasion (e.g., between the resources associated with sync message transmission) in order to transmit or retransmit a command message. The reader may request additional resources associated with a resource instance (e.g., to increase the duration of an AIOT transmission). The reader may request additional resources to prolong the IoT or AIoT operation by one or more access occasions.

The reader may indicate which of these specific requests it is performing by indicating such in the request message. Alternatively or additionally, it may do so by selecting a different Uu resource configured by the network.

A reader may determine whether/which indication to send to the network. A reader may be configured with specific rules for determining whether/when it can send a non-usage indication to the network. Specifically, the reader may determine whether it is allowed to send the indication, and the exact timing for when to send the indication based on one or more of: the RRC state; where in the inventory procedure the failure occurred; the timing of the device response relative to the IoT or AIoT operation; the timing of the device response relative to the IoT or AIoT operation; or some minimum time requirements to inform the network in time.

The reader may determine whether it is allowed to send the indication, and the exact timing for when to send the indication based on the RRC state. For example, a reader performing an IoT or AIoT operation while in RRC_IDLE/RRC_INACTIVE may not be allowed to send the indication, while a reader operating in RRC_CONNECTED may be allowed to send the indication. For example, a reader performing an IoT or AIoT operation while in RRC_IDLE/RRC_INACTIVE may only send the indication once it has transitioned to RRC_CONNECTED.

The reader may determine whether it is allowed to send the indication, and the exact timing for when to send the indication based on where in the inventory procedure the failure occurred. For example, a reader may be allowed to request additional resources (e.g., for command) as long as the failure (e.g., command where a response was not received) occurred in the first X access occasions, where X may be configured by the network.

The reader may determine whether it is allowed to send the indication, and the exact timing for when to send the indication based on the timing of the device response relative to the AIOT operation. The reader may determine whether it is allowed to send the indication, and the exact timing for when to send the indication based on some minimum time requirements to inform the network in time. For example, the reader may request a modification of the resources as long as the resources to be modified occur at least X slots from the time in which the request is sent.

Similarly, the reader may be configured with rules for determining which mechanism it can use to send a non-usage indication. Specifically, the mechanism may refer to the specific resource to use and/or message to use. Specifically, the mechanism may refer to whether the reader waits for confirmation from the network or not. Specifically, the mechanism may refer to determining whether to use one example over another of described herein for sending the indication. The reader may be configured with rules for determining which mechanism it can use to send a non-usage indication based on RRC state. For example, a reader may send the indication using RACH when in RRC_IDLE/INACTIVE, while it may use SR while in RRC_CONNECTED. The reader may be configured with rules for determining which mechanism it can use to send a non-usage indication based on where in the inventory procedure the failure occurred. The reader may be configured with rules for determining which mechanism it can use to send a non-usage indication based on the timing of the resource. For example, if the resource for which modification is being requested has some timing, the reader may use one mechanism over another. The reader may be configured with rules for determining which mechanism it can use to send a non-usage indication based on some minimum time requirements to inform the network in time. For example, the reader may transmit SR when the resource to be modified occurs less than X slots from the SR resource.

A reader may determine whether a device is to be re-paged or can be accessed with its WTRU ID. In one example specific to a device access and addressing, a reader may determine to release the WTRU ID associated with a device and assume that the device will re-access from paging based on certain conditions. Specifically, a device with pending commands to be issued at the reader, or which has succeeded random access but has yet to successfully transmit MSG3, may be addressed by the reader with its WTRU ID to trigger command transmissions, or trigger device retransmissions until a certain condition is met. Upon meeting such condition, the reader may stop transmitting commands to the device. Upon meeting such condition where MSG3 has yet to be received by the reader, the reader may stop sending a MSG3 retransmission request (e.g., a MSG2 transmission that triggers a MSG3 retransmission by the device.

Similarly, at the occurrence of such conditions at the device side, the device may initiate a re-access procedure. Specifically, although the device may have succeeded random access during the current procedure, failure of a command or MSG3 transmission followed by occurrence of any of the below conditions may cause the device to initiate re-access (e.g., respond to paging retransmission) despite having previously responded to the same instance. Specifically, a device may consider an access procedure as unsuccessful if any of the following event occurs.

In one event, the device sends an indication that it lacks energy to perform a transmission (e.g., MSG3, command response). For example, the device may maintain its WTRU ID as long as it has energy to maintain the ID in its registers. If the device is going to run out of energy, it may indicate such to the reader. The reader may then stop any command transmission to the device during a specific inventory or operation. The reader may trigger a paging retransmission which includes the said device and issue the command transmissions at that time (following the device access resulting from the paging retransmission).

In another event, a number of access occasions, sync messages, R2D messages have been received without successful transmission of MSG3 or of the command response. This may occur as a result of the reader down-prioritizing command transmission to the device, for example. This may occur as a result of the device's energy window being exceeded while there are still pending commands at the reader to be sent to the device.

Embodiments for determination of command and/or device are described herein. A reader may be configured with a subset of occasions which contain command resources. In one example, a reader may be configured with, or associate, command resources with only a subset of the access occasions in an inventory procedure. Specifically, based on mechanisms described above, a reader may associate IoT or AIoT resources in time/frequency with transmission of specific IoT or AIoT messages. The reader may therefore receive, be configured with, or associate each of the resources in a resource configuration for an IoT or AIoT procedure with the transmission of one or more IoT or AIoT message type. Within those, a reader may determine that some access occasions (e.g., the resources and time period associated with occasions for a device to perform random access and perform MSG3 transmission) may be configured with resources to perform command transmissions and response reception, while other occasions may not be provided with such resources. Specifically, following the access by a device and transmission by the device of MSG3, the reader may issue additional subsequent commands (e.g., addressing a particular device using its device ID) prior to transmitting another R2D sync message which starts the next occasion.

A reader may defer the transmission of a command until a future occasion. In one example, a reader may receive MSG3 (or a successful random access) from a device in one occasion. The reader may have one or more commands to be issued to the device in question. The reader may decide to issue the command to such a device in a future occasion, rather than the same occasion. Similarly, the reader may decide to issue the command following the completion of the inventory procedure itself. Specifically, the reader may defer the transmission of a pending command to the device to a future occasion based on one or more (or a combination) of: factors associated with the command type; Factors associated with the resources configured for command in the current occasion; factors associated with the priority of the command; factors associated with the device type; factors associated with a transmission by the device during the random access; factors associated with the number of occasions, or the number of remaining occasions; factors associated with the number of devices to respond, the number of devices which have a command pending, possibly of a given type; factors associated with energy availability at a device; factors associated with the length and/or contents of MSG3; factors associated with a required time transmitted by the device; factors associated with the channel conditions; factors associated with the duration of a previous message (e.g., MSG3) and/or resource availability for the command; factors associated with the priority of the inventory and/or the required time to complete the inventory; or factors associated with the amount of time a command has been pending.

The reader may defer the transmission of a pending command to the device to a future occasion based on the factors associated with the command type. For example, if the resources allow issuing a write command, but the device has a read command pending, the reader may defer the command until an occasion where resources for read command are available.

The reader may defer the transmission of a pending command to the device to a future occasion based on the factors associated with the resources configured for command in the current occasion. For example, if the amount of resources associated with the command (e.g., for the D2R transmission) is not sufficient for performing the transmission, the reader may defer the command.

The reader may defer the transmission of a pending command to the device to a future occasion based on the factors associated with the priority of the command. For example, in combination with other factors (e.g., relative priority with inventory), the reader may defer transmission of a command if the command has a low priority.

The reader may defer the transmission of a pending command to the device to a future occasion based on the factors associated with the device type. For example, a reader may defer a command if the device can maintain its context/WTRU ID and can support reception of a command in a future occasion. For example, a reader may defer a command to the next occasion if the device can support reception of the command in the next occasion.

The reader may defer the transmission of a pending command to the device to a future occasion based on the factors associated with a transmission by the device during the random access. For example, the device may send some information to the reader during random access. For example, the device may indicate it cannot complete an operation due to lack of energy. In this case, the reader may defer transmission of a command to a future occasion (or by a configured or predefined number of occasions, or a number of occasions indicated by the device). For example, the device may indicate in a transmission (e.g., in MSG3) that it has high priority data available for transmission. In such a case, the reader may avoid deferring a command to such a device.

The reader may defer the transmission of a pending command to the device to a future occasion based on the factors associated with the number of occasions, or the number of remaining occasions. For example, if the number of occasions, or number of remaining occasions is larger than a threshold, the reader may defer transmission of a command to a future occasion. For example, if the number of remaining occasions with resources available for command transmission is above a threshold, the reader may defer transmission of a command to a subsequent occasion.

The reader may defer the transmission of a pending command to the device to a future occasion based on the factors associated with the number of devices to respond, the number of devices which have a command pending, possibly of a given type. For example, if the number of devices which have a command pending is smaller than a threshold, the reader may defer transmission of a command to a future occasion.

The reader may defer the transmission of a pending command to the device to a future occasion based on the factors associated with energy availability at a device. For example, if a device does not have energy available for command reception, the reader may defer command transmission to a future occasion.

The reader may defer the transmission of a pending command to the device to a future occasion based on the factors associated with the length and/or contents of MSG3. For example, the length and/or contents of MSG3 received by the reader may implicitly indicate another factor herein (e.g., availability of high priority data). For example, if the upper layer WTRU ID received in MSG3 is one of a configured number of IDs, within a group of configured IDs, and/or the like, the reader may/may not be allowed to defer the transmission to a subsequent occasion.

The reader may defer the transmission of a pending command to the device to a future occasion based on the factors associated with a required time transmitted by the device. For example, the device may transmit a required time for completion of a command (e.g., in MSG3). The reader may determine whether to defer transmission of a command based on whether the required time for the device is still met after deferral.

The reader may defer the transmission of a pending command to the device to a future occasion based on the factors associated with the channel conditions. For example, the device may decide whether command deferral is required or not based on the channel conditions combined with the size of the resources available for transmission. Specifically, if the resources available for transmission are not sufficient to transmit the command or receive the data from the device considering the measured IoT or AIoT channel conditions with the device, the reader may defer the command to a future occasion.

The reader may defer the transmission of a pending command to the device to a future occasion based on the factors associated with the duration of a previous message (e.g., MSG3) and/or resource availability for the command. For example, MSG3 transmission may occupy a portion of resources which can be used by the reader for command transmission and/or command response reception. If MSG3 transmission duration is longer than a threshold, or the remaining resources following MSG3 transmission is smaller than a threshold and/or does not allow command transmission, the reader may defer command transmission to a subsequent occasion.

The reader may defer the transmission of a pending command to the device to a future occasion based on the factors associated with the priority of the inventory and/or the required time to complete the inventory. For example, inventory procedure itself may be assigned a priority or completion time requirement. Specifically, reception of MSG3 by some or all of the devices may have a completion time requirement. For example, a reader may defer command transmission to a subsequent occasion if at least a subset of devices has already completed inventory procedure (have transmitted MSG3). For example, a reader may defer a command transmission (e.g., to the end of the inventory) if the inventory itself may not complete by a required amount of time. In such case, the reader may repurpose resources associated with command transmission into sending sync/MSG2 and receiving MS1/MSG3, to allow completion of the inventory on time.

The reader may defer the transmission of a pending command to the device to a future occasion based on the factors associated with the amount of time a command has been pending. For example, a command may be deferred to a subsequent occasion as long as the command has been pending for less than a threshold time, or threshold number of occasions.

In a related embodiment, a reader may have multiple commands pending at a given time during an inventory procedure. For a given occasion, the reader may select one device (e.g., having a pending command that may have been deferred to a subsequent occasion) and/or command to perform using the resources configured for that occasion. In selection of the device and/or command, the reader may use the similar factors above for the selection. For example, the reader may select the device and/or command which has been pending for the minimum amount of time, assuming all other conditions command transmission for the commands are met.

A reader may indicate to a device the deferral of a command. In one example, a reader which defers a command to a subsequent occasion, or to the end of the inventory, may indicate such to the device. For example, the reader may include the indication of deferral to the device in a R2D message (e.g., MSG2, sync message after MSG3, ACK message to the device after correctly receiving MSG3). The reader may further indicate the occasion number where the command for the device will be transmitted. The reader may further indicate the amount of time (e.g., the number of occasions) over which the device should be prepared to receive a command. Specifically, such time may correspond to the time over which the device should maintain its WTRU ID and be addressable by the device via a WTRU ID. Upon expiry of such time without reception of a command, the device may release its WTRU ID and perform re-access as described herein. Alternatively or additionally, upon completion of a command, the device may release its WTRU ID and assume the inventory and command procedure was successful.

A reader may trigger a request for additional resources. In one example, a reader may trigger a request for additional resources based on one of the factors above. Specifically, if the requirements for a command (e.g., the maximum time window for issuing a command) may not be met with the current resource configuration, the reader may trigger a resource request using the mechanisms described herein. In another example, if the inventory procedure may not be met on time with the current resource configuration (e.g., due to the reader using some resources for commands interleaved with inventory), the reader may issue a command request.

In another example, a reader may trigger a request for additional resources following an inventory procedure where there is still at least one command to perform (e.g., that the reader was not able to perform interleaved with inventory with the provided resource configuration).

Embodiments for indication of resource usage/non-usage/modification sent to one or more IoT or AIoT devices are described herein. A reader may provide signaling to in-range devices to assist in adapting to changing link conditions. As described in FIG. 4, a reader may initiate the inventory procedure for any particular device with the transmission of a Query or QueryRep message. The initial Query may comprise an estimate for the number of expected QueryRep occasions, Q_initial, based on the reader estimate of the expected number of QueryRep occasions given the probability of command interrupts, the maximum number of possible QueryRep occasions possible within the resource allocated by the BS (e.g., gNB) to the reader, or the like.

Upon reception of MSG1 from a target device in an inventory procedure and assuming contention has been resolved, the reader may decide that the device is also a candidate for completing an additional command immediately after the inventory procedure is concluded for the target device. The reader may indicate to the device that an additional resource will be allocated for this command. This command interrupt indication may include one or more of: device SA ID; reader ID; command type and relevant memory parameters (e.g., read/write memory address, format, or the like); command time domain resource allocation(TDRA); command frequency domain resource allocation Federated Deep Reinforcement Architecture (FDRA); or transmission parameters for command completion including command modulation and coding and/or command repetition rate.

Alternatively or additionally, reception of the command interrupt indication may indicate the start of a command interrupt monitoring timer initiated by the device to be used a reference for the resource allocation for the device to complete the command operation. This timer may be specified, configured by the reader, or indicated dynamically via the reader. The reader may determine this timer duration based on one or more of: a number of completed QueryRep occasions; a number of remaining QueryRep occasions; link quality between the reader and device; expected energy availability of the target device; or completed command interrupt occasions within the current inventory procedure.

The reader may resume the inventory procedure for other devices with the option, for example, to indicate to the target device an allocation for a command before the command interrupt monitoring timer expires. If the reader does not determine that a command interrupt indication is required at conclusion of the current Query/QueryRep occasion, the reader may transmit a no command indication and initiate an updated timer for the start of the next Query/QueryRep occasion. This timer may be broadcast to the devices as system information in the QueryRep message, or multi-cast to, for example, the device groups indicated in the inventory procedure. Alternatively or additionally, the timer may be specified to a fixed value. This timer may be decremented by an internal clock reference within the reader, or based on reference timing from the Uu interface, or the like. Upon expiration of the time, the reader may transmit the next QueryRep transmission.

The reader may determine, for example, based on link quality, number of command interrupt occasions, pre-emption of the inventory process via the Uu interface, that the number of available. QueryRep occasions may be updated from the initial value to Q_{new}. This updated value may be indicated to the devices via broadcast, or multicast to the devices indicated by the inventory procedure.

Alternatively or additionally, the command interrupt indication, command interrupt monitoring timer, and the Q_{new}indication may be provided to the relevant devices in an additional message (e.g., MSG4) transmitted after the successfully reception of MSG3 by the target device. The resource allocation for MSG4 may be broadcast as system information by the reader, multicast to a group of indicated devices, or specified to a fixed set of values.

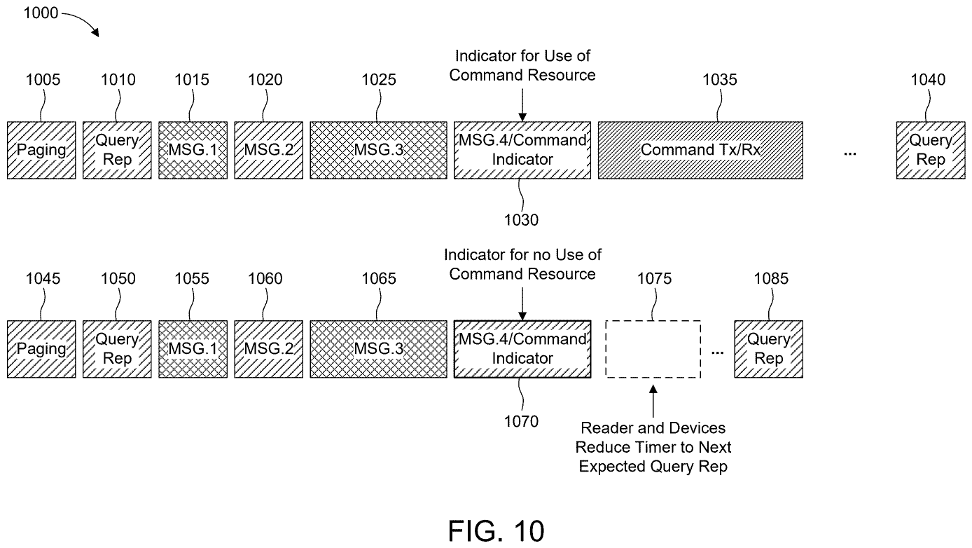

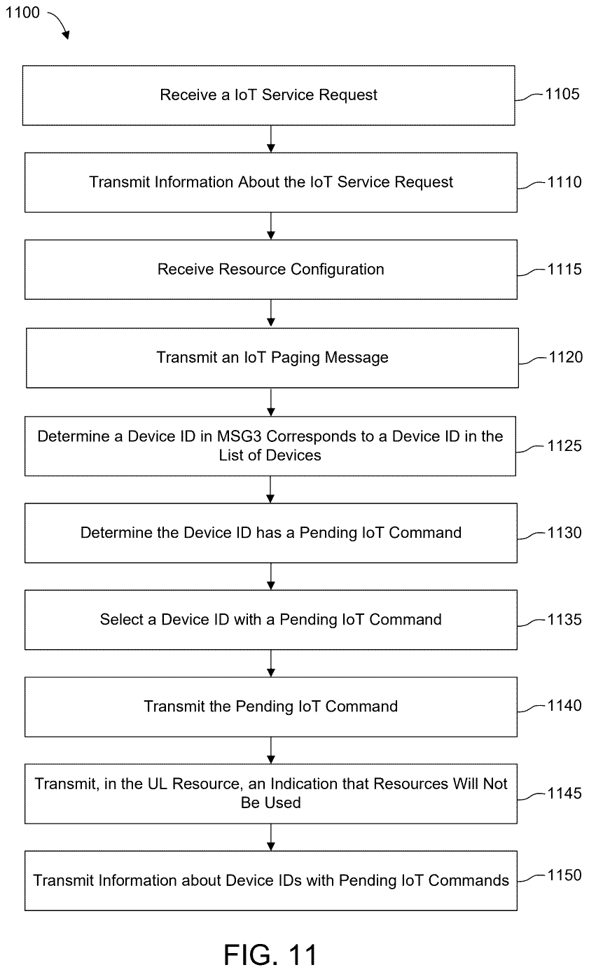

FIG. 10 illustrates an example transmission 1000 indicating a command interrupt, which may be used in combination with any of other embodiments described herein. As illustrated in FIG. 10, MSG4 1030, 1070 may be used to indicate both a command interrupt and an occasion in which no command interrupt is schedule. For example, after the reader and devices exchange a paging message 1005, 1045, QueryRep 1010, 1050, MSG1 1015, 1055, MSG2 1020, 1060, MSG3 1025, 1065, the reader may transmit MSG4 1030, 1070 to indicate either the presence or lack of a command interrupt. For example, the reader may transmit MSG4 1030 to indicate the use of command resources such as command TX/RX 1035. The reader may also transmit MSG4 1070 to indicate no use of command resources 1075. In this case, the reader and devices may reduce the timer to the next expected QueryRep 1080.

If the target device's counter has reached 0 upon reception of the Query or QueryRep, the device may decide to transmit MSG1 in the available resource. The device may then monitor for MSG2 from the reader, providing the necessary configuration for MSG3 and also relevant configuration of a possible command interrupt event. If the target device correctly receives MSG2 and identifies that a command interrupt event is indicated, it may prepare to conclude the inventory procedure with the transmission of MSG3 and then prepare either to complete the command interrupt based on the configuration details provided by the command interrupt indicator. The command interrupt indicator may include, but is not limited to: device SA ID; reader identification; command type and relevant memory parameters (e.g., read/write memory address, format, or the like); command TDRA; command FDRA; and transmission parameters for command completion including command modulation and coding and/or command repetition rate.

If the target device is indicated to transmit based on the command type (e.g., read command) indicated by the command interrupt indication, the device may prepare a transmission of data read from the memory address indicated using the resource allocation provided by the indication and the relevant modulation, coding, and repetition parameters indicated by the reader. Alternatively or additionally, if the device is indicated to receive a transmission from the receiver based on the command type (e.g., write command) indicated by the reader, the device may be configured to receive a transmission in the indicated TDRA/FDRA indicated by the reader using the modulation, coding, and repetition configuration indicated. Alternatively or additionally, upon successful reception of MSG2, the device may initiate a command interrupt monitoring timer. This timer may be decremented based on, for example, an internal clock reference within the device, a successful reception of a QueryRep transmitted by the reader, and/or the like. The device may monitor for a command interrupt indication from the reader while this command interrupt monitoring timer is active.

The target device and other devices may monitor for a no command interrupt indication from the reader. The monitoring occasion for any one of several no command interrupt indication occasions may be broadcast as system information, multi-cast to a group of devices indicated as part of the inventory process or specified as part of the inventory process schedule. Upon successful reception of the no command interrupt indication, each device may update its schedule for the monitoring of the next QueryRep occasion.

The target device may also receive a Q_{new} update indication from the reader. Each device may select an updated backoff slot for transmission of MSG1 based on the updated Q_{new}.

Alternatively or additionally, the device may monitor for command interrupt indication, the command interrupt monitor window, or the Q_{new} update indication via an additional MSG (e.g., MSG4) received after successful transmission of MSG3.

In one embodiment, a WTRU may select an IoT or AIoT command (and the corresponding device) to be transmitted during an occasion based on the resources configured (e.g., resources sufficient for read/write command) and the time for which the command has been pending. The WTRU may indicate the release of an instance of statically configured Uu resources based on the absence of a pending IoT or AIoT command that matches resources configured in that instance.

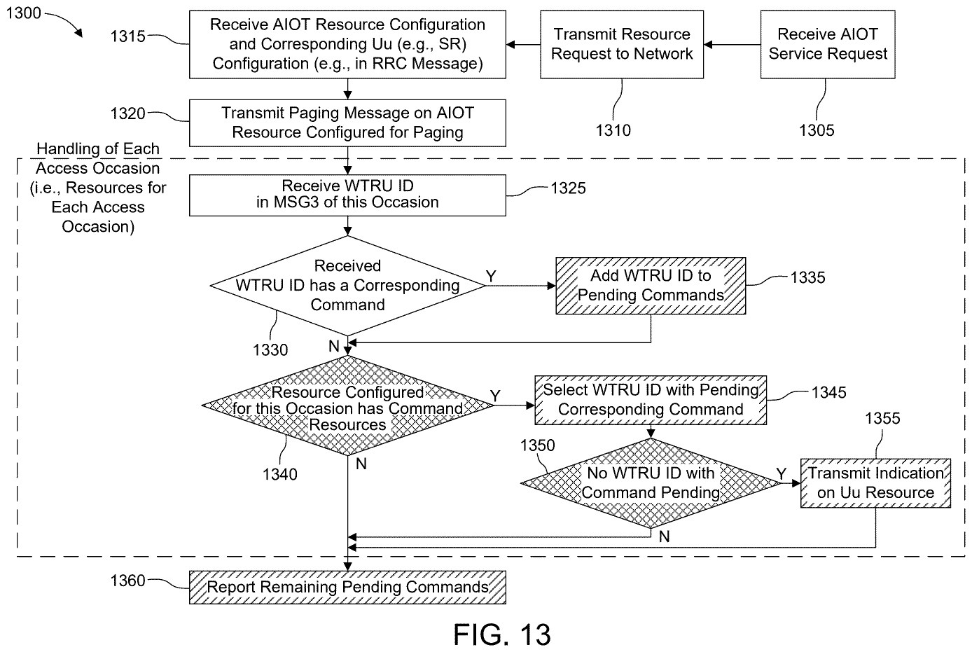

FIG. 13 illustrates an example procedure 1100, which may be used in combination with any of other embodiments described herein. In FIG. 3, a WTRU may be an intermediate node 615 or an intermediate WTRU in topology 600 of FIG. 6. At 1105, an IoT service request (e.g., inventory, or inventory+command) may be received. For example, the WTRU may receive the IoT service request from the CN, a BS, a server, and/or a network function. The WTRU may receive the IoT service request in a NAS message and/or in an RRC message. The WTRU may receive the IoT service request from the CN via a BS. The WTRU may receive the IoT service request from application layers or WTRU/UE upper layers in the CN. The CN may be the termination point of the NAS or the upper/application layer. The CN may be the originator of the IoT or AIoT service or service request. The IoT service request may be a new IoT or AIoT service request (e.g., inventory+command). The IoT service request may comprise one or more of: a paging ID, a list of IoT or AIoT commands (e.g., read command, write command, disable, or the like), a list of device IDs associated with each IoT or AIoT command.

At 1110, information about the received IoT service request may be transmitted. For example, the WTRU may transmit information about the received IoT or AIoT service request. The WTRU may transmit the information to a BS (e.g., a gNB) and/or in an RRC message. The information may comprise one or more of: the paging ID, number of IoT or AIoT commands, and/or command types. In case that the BS is aware of the IoT or AIoT server request or operation, steps 1105 and/or 1110 may be omitted.

At 1115, a resource configuration or resource configuration information may be received. For example, the WTRU may receive the resource configuration to be used for the service request. The WTRU may receive the resource configuration from the BS, the CN, a server, a network function, or the like. The TWRU may receive the resource configuration in a NAS message, and/or an RRC message. The resource configuration may comprise one or more of: a resource for transmission of an IoT or AIoT paging message; N resource groups (e.g., N=number of access occasions); or a set of (e.g., at most N) UL resources (e.g., SR resources). Each of the N resource groups (e.g., N=number of access occasions) may comprise one or more of: resources for reception (e.g., MSG1 reception, MSG3 reception, command ACK, or the like); resources for transmission (e.g., MSG2, or the like); resources for IoT or AIoT command transmission; resources for data reception; or an associated IoT or AIoT command type. Each of the N resource groups may correspond to an occasion or an access occasion. Each of the set of (e.g., at most N) UL resources (e.g., SR resources) may be associated with a resource group of the N resource group. For example, resource groups may be configured with one or more of a resource for command transmission and/or a resource for data reception and the UL resource may be used to indicate that the resources for command transmission and/or data reception in the resource group will not be used.

At 1120, an IoT or AIoT paging message may be transmitted. For example, the WTRU may transmit an IoT or AIOT paging message to one or more devices. The paging message may comprise at least the paging ID of the received IoT or AIoT service request. In addition to the paging message, the WTRU may perform the random access procedure with the one or more devices. For example, the WTRU may exchange MSG1, MSG2, and MSG3 with the one or more devices. The MSG3 may include one or more device IDs associated with the one or more devices.

At 1125, the WTRU may determine that a device ID received in the MSG3 correspond to a device ID in the list of devices IDs of the IoT or AIoT service request. Specifically, for a resource group of the configured N resource groups, the WTRU may determine that the device ID included in MSG3 received in resources for reception of the resource group corresponds to the device ID in the list of device IDs of the received IoT or AIoT service request.

At 1130, the WTRU may determine whether there is a pending IoT or AIoT command for the device or device ID. For example, the WTRU may determine that the device ID received in the MSG3 has (or is associated with) a pending IoT or AIoT command. The pending IoT or AIoT command may correspond to an IoT or AIoT command included in the received IoT or AIOT service request that has not yet been executed.

At 1135, the WTRU may select, based on a resource group, a device ID with a pending command. For example, if the resource group has one or more of resource for command transmission or resource for data reception, the WTRU may select a device ID with a pending IoT or AIoT command. For example, in a first occasion associated with a first resource group, the WTRU that received MSG3 from a first device may determine that the fist device has a first command but no resource associated with the first command. The first command may become pending. In a second occasion associated with a second resource group, the WTRU that received another MSG3 from a second device may determine that the second device has a second command (that has not been executed) and the second resource group has a resource for the second command. The WTRU may select which command the WTUR will transmit from among the two pending commands (i.e., the first and second commands). The selection may be based on one or more of: pending IoT or AIoT command type of the device ID; IoT or AIoT command type associated with the resource group (e.g., the selection is based on the pending IoT or AIoT command type of the device ID matching the IoT or AIoT command type associated with the resource group); a device ID; or duration of time that the IoT or AIoT command has been pending.

At 1145, the pending IoT or AIOT command of the selected device ID may be transmitted. For example, the WTRU may transmit the pending IoT or AIoT command of the selected device ID using the resources for command transmission of the resource group. At 1145, if no device ID is selected (e.g., none satisfy the selection criteria), an indication that the resource for command transmission or the resource for data reception will not be used may be transmitted. For example, if the WTRU determines that none of device IDs is selected based on the selection criteria, the WTRU may transmit, using the UL resource associated with the resource group, an indication that the resource group's resource for command transmission or the resource group's resource for data reception will not be used. The indication may be transmitted to the BS, the CN, the server, the network function, and/or the like. The step 1145 may or may not be performed based on the selection result.

At 1150, information about device IDs with pending IoT or AIoT commands may be transmitted. For example, the WTRU may transmit an indication of one or more of: the number of devices IDs with pending AIoT commands, the pending command types, or the like. The indication may be transmitted to the BS, the CN, the server, the network function, and/or the like. The step 1150 may or may not be performed.

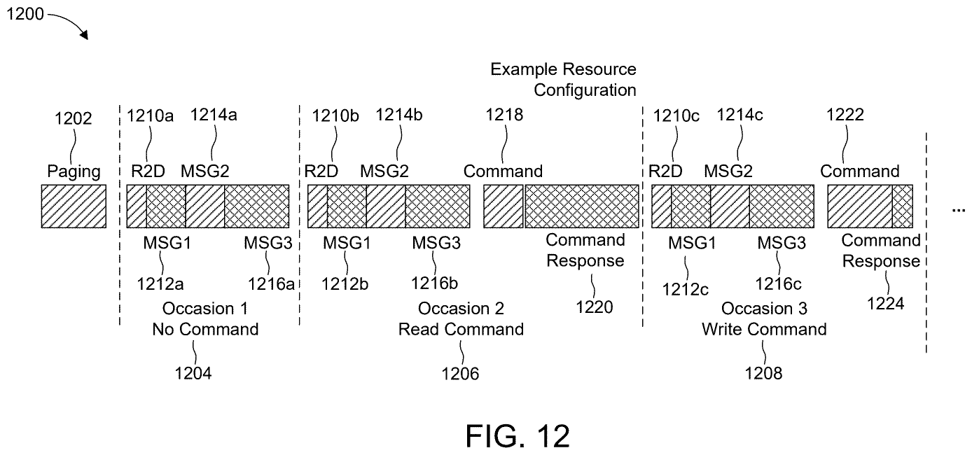

FIG. 12 illustrates an example resource configuration 1200 (or resource configuration information), which may be used in combination with any of other embodiments described herein. The resource configuration 1200 may comprise time and/or frequency resources allocated to the intermediate WTRU by the network (e.g., BS). As illustrated in FIG. 12, the resource configuration may comprise N resource groups. For example, the first resource group may be associated with occasion 1 1304. The first resource group may comprise one or more resources dedicated for an R2D message 1310a (e.g., Query, QueryRep, QueryAdjust, or the like), one or more resources dedicated for MSG1 1312a, one or more resources dedicated for MSG2 1314a, and one or more resources dedicated for MSG3 1316a. The second resource group may be associated with occasion 2 1306. The second resource group may comprise one or more resources dedicated for an R2D message 1310b (e.g., Query, QueryRep, QueryAdjust, or the like), one or more resources dedicated for MSG1 1312b, one or more resources dedicated for MSG2 1314b, and one or more resources dedicated for MSG3 1316b, one or more resources dedicated for a command 1318, and one or more resources dedicated for a command response 1320. The third resource group may be associated with occasion 3 1308. The third resource group may comprise one or more resources dedicated for an R2D message 1310c (e.g., Query, QueryRep, QueryAdjust, or the like), one or more resources dedicated for MSG1 1312c, one or more resources dedicated for MSG2 1314c, and one or more resources dedicated for MSG3 1316c, one or more resources dedicated for a command 1322, and one or more resources dedicated for a command response 1324.

Such resource configuration 1200 may be received in a message such as an RRC message or a NAS message and may comprise one or more parameters that define the amount of time and/or frequency resources associated with each message (e.g., MSG1, MSG2, or the like), each transmission type (e.g., transmission/reception), and/or command type (e.g., read command, write command, or the like). The resource configuration 1200 may semi-statically define resources for a number of occasions or period of time. The resource configuration 1200 associated with each occasion 1304, 1306, 1308 may be configured for a specific type (e.g., no command, read command, write command, or the like). For example, the first resource group associated with occasion 1 1340 may be a no command type. The second resource group associated with occasion 2 1306 may be a read command type. The third resource group associated with occasion 3 1308 may be a write command type. Such types may be specified (e.g., type 1, type 2, or the like) and the ability of a WTRU to use a resource configuration for a specific type of command (e.g., read, write, or the like) may be specified, or configured (e.g., in another RRC message).

FIG. 13 illustrates an example procedure 1300 in a WTRU (or UE), which may be used in combination with any of other embodiments described herein. In FIG. 13, the WTRU may be an intermediate node 615 or intermediate WTRU in topology 600 of FIG. 6.

As described above, the IoT or AIoT service may be initiated at the WTRU which triggers the WTRU to request and receive a resource configuration to be used for the service, and to transmit an IoT or AIoT paging message for the service. For each occasion (and corresponding resources for the occasion) configured by the network, the WTRU may monitor whether a device ID is received on the IoT or AIoT resources, and whether the device ID has a corresponding command associated with it (i.e., in the service request).

For occasions where the device ID is received, the reader checks the list of device IDs received in the service request to see if a command was also received for that device ID. If received, the reader considered this command as pending. It may service this command on this specific occasion or may do so in a future or upcoming occasion. In one option, the reader adds the device ID as pending and considers the selection of the command to be issued based on all pending commands.

For the current occasion, the WTRU selects the device ID and/or pending command based on the configured resources associated with that occasion. Specifically, if the resources allow for the transmission of a read command, the WTRU may select a pending device ID and/or pending command to be transmitted to a WTRU which was associated with a read command in the initial service request. If multiple such device IDs exist, the WTRU may select the device with the longest pending command (e.g., the device which succeeded the access procedure first). If no pending commands and/or devices are determined which can be issued using the configured resources, the WTRU may indicate such to the network, by transmitting in a Uu resource (e.g., SR) reserved for such purpose. This allows the network to reallocate the resources for other purposes. Finally, if the occasion is not configured with any command resources, the reader WTRU may not transmit any commands on that occasion.

When all occasions are completed, the WTRU may still have pending devices and/or commands still to be issued. Such commands may require additional resources from the network. The WTRU may send information about such commands (e.g., the number of commands, the command type, or the like) to the network (e.g., in an RRC message).

As illustrated in FIG. 13, at 1305, the WTRU may receive an IoT or AIoT service request from a CN. At 1310, the WTRU may transmit, to a BS, a request message for resource configuration. At 1315, the WTRU may receive, from the BS, the resource configuration to be used for the IoT or AIoT service. At 1320, the WTRU may transmit a paging message using a resource configured for paging in the resource configuration. At 1325, for each occasion, the WTRU may receive a device ID in MSG3 using resources configured for the MSG3 in the occasion. At 1330, for each occasion, the WTRU may determine whether the device ID received in the MSG3 has a corresponding command in the service request (e.g., a command in the list of commands included in the service request). The WTRU may check the list of device IDs received in the service request to determine whether a command was also received for the device ID in the list of device IDs. If the command was received, the WTRU determines the command as pending. At 1335, the WTRU may add the command for the device ID received in the MSG3 as a pending command. At 1340, the WTRU may determine whether the resource configured for the occasion has command resources for the pending command. If the resource configured for the occasion has command resources for the pending command, at 1345, the WTRU may select the device ID and/or the pending command for the occasion. For example, if the resources allow for the transmission of a read command, the WTRU may select a device ID and/or a pending command to be transmitted. If multiple device IDs with multiple pending commands exist, the WTRU may select a device ID and/or a pending command based on the selection criteria as described above. For example, the WTRU may select a device ID and/or a pending command based on the duration of time that the multiple commands have been pending. At 1359, the WTRU may determine whether a device ID and/or a pending command is selected. If no device ID and/or pending command is selected, the WTRU may transmit an indication that the resources for command transmission or data reception will not be used using Uu resources. At 1360, the WTRU may report the remaining pending commands to the network.

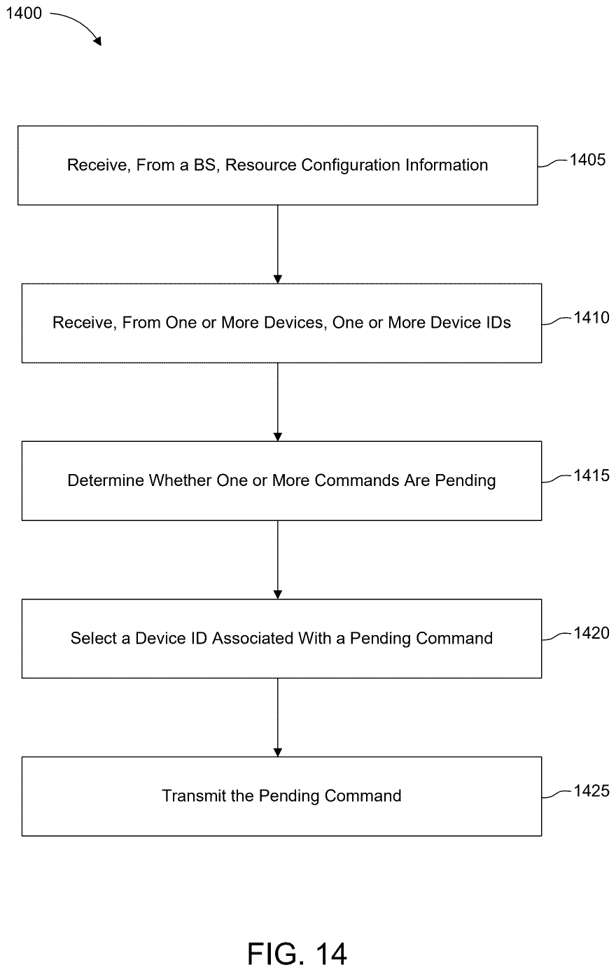

FIG. 14 illustrates an example procedure 1400, which may be used in combination with any of other embodiments described herein. At 1405, a WTRU may receive, from a BS, resource configuration information. The resource configuration information may comprise one or more resource groups. Each of the one or more resource groups may comprise one or more resources. For example, the one or more resources in each of the one or more resource groups may comprise one or more resources for reception, one or more resources for transmission, one or more resources for command transmission, one or more resources for data reception, and one or more command type associated with the one or more resources. The resource configuration information may further comprise a resource for paging or paging message transmission, and a set of uplink resources (e.g., SR resources). Each uplink resource may be associated with a resource group of the one or more resource groups. The WTRU may be a network node between a BS and one or more devices (e.g., IoT devices). For example, the WTRU may be an intermediate node 615 or intermediate WTRU in topology 600 of FIG. 6 At 1410, the WTRU may receive, from one or more devices, one or more respective device identifications that corresponds to the one or more devices. The one or more device identifications may be included in one or more respective messages. For example, the WTRU may receive, from a first device, a first message that includes a first device identification associated with the first device. The WTRU may receive, from a second device, a second message that includes a second device identification associated with the second device. The first and/or second messages may be MSG3. The messages that include the device identifications may be messages received during the random access procedures with the devices. The one or more devices may be one or more IoT devices or AIoT devices.

At 1415, the WTRU may determine whether one or more commands are pending for the one or more devices. For example, the WTRU may receive a service request that comprises a list of device identifications and a list of commands. Each command in the list of commands may be associated with a device identification in the list of device identifications. The WTRU may transmit, to the BS, a request for the resource configuration. The request comprises information associated with the service request. The WTRU may determine, for each of the one or more resource groups (or for each occasion), that a device identification of the one or more device identifications (e.g., received in the MSG3) corresponds to a device identification of the list of device identifications (e.g., received in the service request). Based on the received device identification (e.g., received from the one or more devices) corresponding to the device identification in the list of device identifications (e.g., received from the BS), the WTRU may identify the corresponding command (e.g., in the list of commands in the service request) associated with the received device identification and determine that there is a pending command for the received device identification (e.g., received from the one or more devices). The pending command may be a command included in the service request but has not yet been executed.

At 1420, the WTRU may select a device identification associated with a pending command from among the one or more device identifications. For example, the WTRU may select a device identification associated with a pending command based on one or more resources in a resource group. If the one or more resources in the resource group include resources for command transmission or for data reception, the WTRU may select the device identification to perform the pending command. In case there are multiple device identifications associated with multiple pending commands, the WTRU may select, based on the duration of time that the multiple commands have been pending, the device identification from among the multiple device identifications. For example, for a first resource group of the one or more resource groups (or first occasion), the WTRU may determine that a first command is pending for a first device of the one or more devices. The first device may be associated with a first device identification of the one or more device identifications. For a second resource group of the one or more resource groups (or second occasion), the WTRU may determine that a second command is pending for a second device of the one or more devices. The second device may be associated with a second device identification of the one or more device identifications. The WTRU may select, based on a first duration of time that the first command has been pending and a second duration of time that the second command has been pending, the second device identification with the second command as the device identification associated with the pending command. In this case, the second duration of time is longer than the first duration of time.

In one embodiment, the WTRU may select, based on a command type associated with the pending command and a command type associated with the resource group, the device identification with the pending command from among the one or more device identifications. The command type associated with the pending command may correspond to the command type associated with the resource group. Specifically, when the WTRU selects a device identification to transmit the pending command in an occasion (or in a resource group), the resources for the occasion (or in the resource group) need to be applicable to the transmission of the command type that the device has for transmission. For example, if the pending command for the device identification is a read command, that command can only be transmitted in an occasion (or in a resource group) where the resource allows the transmission of a read command (e.g., not in occasions or resource group where the resources allow transmission of write commands).

In another embodiment, the WTRU may select, based on the device identification in the list of device identifications, the device identification associated with the pending command from among the one or more device identifications. Specifically, the WTRU may receive a list of device identities in the service request and determine the corresponding command for the device identification that has a command to be sent as part of the service request. When the WTRU receives, from a device, a device identification, the WTRU may identify the device identification received from the device and determine if the received device identification is associated with a command to be issued in the list of device identifications. If the received device identification is associated with a command to be issued in the list of device identifications, the WTRU may select the device identification associated with the pending command to transmit the pending command.

Once the device identification associated with the pending command is selected, at 1425, the WTRU may transmit the pending command. For example, the WTRU may send the pending command to the device associated with the device identification. For example, the WTRU may send the pending command using the one or more resources in the resource group. The one or more resources in the resource group may be resources for command transmission and/or resources for data reception.

In one embodiment, the WTRU may determine that no device identification is selected from among the one or more device identifications. In other words, the WTRU may determine that none of the one or more device identifications satisfy the selection criteria described above. Based on the determination that no device identification is selected, the WTRU may transmit, using one or more uplink resources associated with the one or more resource groups, an indication that one or more resources of the one or more resource groups will not be used. The one or more resources may be for command transmission or data reception. The one or more uplink resources may be included in the resource configuration information. In an example, the one or more uplink resources may be scheduling request (SR) resources. The indication may be transmitted to the BS, the CN, a server, a network function, and/or the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving, from a base station (BS), resource configuration information that comprises one or more resource groups, wherein each of the one or more resource groups comprises one or more resources;
receiving, from one or more devices, one or more respective device identifications that correspond to the one or more devices;
determining, for the one or more resource groups, whether one or more commands are pending for the one or more devices;
selecting, based on one or more resources in a resource group, a device identification associated with a pending command from among the one or more device identifications; and
transmitting, based on the selected device identification, the pending command using the one or more resources in the resource group.

2. The method of claim 1, further comprising:
selecting, based on duration of time that the one or more commands have been pending, the device identification from among the one or more device identifications.

3. The method of claim 2, further comprising:
determining, for a first resource group of the one or more resource groups, that a first command is pending for a first device of the one or more devices, wherein the first device is associated with a first device identification of the one or more device identifications;
determining, for a second resource group of the one or more resource groups, that a second command is pending for a second device of the one or more devices, wherein the second device is associated with a second device identification of the one or more device identifications; and
selecting, based on a first duration of time that the first command has been pending and a second duration of time that the second command has been pending, the second device identification with the second command as the device identification associated with the pending command, wherein the second duration of time is longer than the first duration of time.

4. The method of claim 1, further comprising:
selecting, based on a command type associated with the pending command and a command type associated with the resource group, the device identification with the pending command from among the one or more device identifications.

5. The method of claim 4, wherein the command type associated with the pending command corresponds to the command type associated with the resource group.

6. The method of claim 1, further comprising:
receiving a service request that comprises a list of device identifications and a list of commands, wherein each command in the list of commands is associated with a device identification in the list of device identifications; and
transmitting, to the BS, a request for the resource configuration, wherein the request comprises information associated with the service request.

7. The method of claim 6, further comprising:
determining, for each of the one or more resource groups, that a device identification of the one or more device identifications corresponds to a device identification of the list of device identifications; and
determining that there is a pending command for the device identification of the one or more device identifications.

8. The method of claim 6, further comprising:
selecting, based on the device identification in the list of device identifications, the device identification associated with the pending command from among the one or more device identifications.

9. The method of claim 1, further comprising:
determining that no device identification is selected from among the one or more device identifications; and
based on the determination that no device identification is selected, transmitting, using one or more uplink resources associated with the one or more resource groups, an indication that one or more resources of the one or more resource group will not be used, wherein the one or more resources are for command transmission or data reception and the one or more uplink resources are included in the resource configuration information.

10. The method of claim 1, wherein the one or more resources in each of the one or more resource groups comprise one or more resources for reception, one or more resources for transmission, one or more resources for command transmission, one or more resources for data reception, and one or more command type associated with the one or more resources.

11. A wireless transmit/receive unit (WTRU) comprising:
a processor;
a receiver; and
a transmitter,
the processor and the receiver configured to:
receive, from a base station (BS), resource configuration information that comprises one or more resource groups, wherein each of the one or more resource groups comprises one or more resources; and
receive, from one or more devices, one or more respective device identifications that correspond to the one or more devices;
the processor configured to:
determine, for the one or more resource groups, whether one or more commands are pending for the one or more devices; and
select, based on one or more resources in a resource group, a device identification associated with a pending command from among the one or more device identifications; and
the processor and the transmitter configured to:
transmit, based on the selected device identification, the pending command using the one or more resources in the resource group.

12. The WTRU of claim 11, wherein the processor is further configured to:
select, based on duration of time that the one or more commands have been pending, the device identification from among the one or more device identifications.

13. The WTRU of claim 12, wherein the processor is further configured to:
determine, for a first resource group of the one or more resource groups, that a first command is pending for a first device of the one or more devices, wherein the first device is associated with a first device identification of the one or more device identifications;
determine, for a second resource group of the one or more resource groups, that a second command is pending for a second device of the one or more devices, wherein the second device is associated with a second device identification of the one or more device identifications; and
select, based on a first duration of time that the first command has been pending and a second duration of time that the second command has been pending, the second device identification with the second command as the device identification associated with the pending command, wherein the second duration of time is longer than the first duration of time.

14. The WTRU of claim 11, wherein the processor is further configured to:
select, based on a command type associated with the pending command and a command type associated with the resource group, the device identification with the pending command from among the one or more device identifications.

15. The WTRU of claim 14, wherein the command type associated with the pending command corresponds to the command type associated with the resource group.

16. The WTRU of claim 11, wherein the processor and the receiver are further configured to receive a service request that comprises a list of device identifications and a list of commands, wherein each command in the list of commands is associated with a device identification in the list of device identifications, and the processor and the transmitter are further configure to transmit, to the BS, a request for the resource configuration, wherein the request comprises information associated with the service request.

17. The WTRU of claim 16, wherein the processor is further configured to:
determine, for each of the one or more resource groups, that a device identification of the one or more device identifications corresponds to a device identification of the list of device identifications; and
determine that there is a pending command for the device identification of the one or more device identifications.

18. The WTRU of claim 16, wherein the processor is further configured to:
select, based on the device identification in the list of device identifications, the device identification associated with the pending command from among the one or more device identifications.

19. The WTRU of claim 11, wherein the processor and the transmitter are further configured to:
determine that no device identification is selected from among the one or more device identifications; and
based on the determination that no device identification is selected, transmit, using one or more uplink resources associated with the one or more resource groups, an indication that one or more resources of the one or more resource group will not be used, wherein the one or more resources are for command transmission or data reception and the one or more uplink resources are included in the resource configuration information.

20. The WTRU of claim 11, wherein the one or more resources in each of the one or more resource groups comprise one or more resources for reception, one or more resources for transmission, one or more resources for command transmission, one or more resources for data reception, and one or more command type associated with the one or more resources.
